(19) United States
(12) Patent Application Publication
(10) Pub. No.: US 2024/0419958 A1
(43) Pub. Date: Dec. 19, 2024

(54) COHERENT ISING MACHINE WITH OPTICAL ERROR CORRECTION FOR OPTIMIZATION SOLUTION GENERATOR SYSTEM AND METHOD

(71) Applicants: NTT RESEARCH, INC., Sunnyvale, CA (US); THE UNIVERSITY OF TOKYO, TOKYO (JP)

(72) Inventors: Sam REIFENSTEIN, Sunnyvale, CA (US); Satoshi KAKO, Synnyvale, CA (US); Timothee LELEU, Tokyo (JP); Yoshihisa YAMAMOTO, Sunnyvale, CA (US)

(73) Assignees: NTT RESEARCH, INC., Sunnyvale, CA (US); THE UNIVERSITY OF TOKYO, Tokyo (JP)

(21) Appl. No.: 18/683,096

(22) PCT Filed: Aug. 17, 2022
(86) PCT No.: PCT/US2022/040647

§ 371 Date: Feb. 12, 2024

Related U.S. Application Data
(60) Provisional application No. 63/234,127, filed on Aug. 17, 2021.

(51) Int. Cl. G06N 3/067; G06N 3/047

(52) U.S. Cl. CPC G06N 3/0675; G06N 3/047

(57) ABSTRACT

A coherent Ising machine may comprise a pump pulse generator configured to generate optical signal pulses; an optical error correction circuit configured to generate optical error pulses; and a main ring cavity configured to store the optical signal pulses and the optical error pulses, wherein the optical error pulses cause the coherent Ising machine not to converge on a local minima of Ising solution and continue to explore nearby states.

### CROSS REFERENCE

This application claims priority from U.S. Provisional application 63/234,127 filed 17 Aug. 2021, the entirety of which is hereby incorporated by reference.

### APPENDICES

Appendix A-F (8 pages) disclose: 1) optimization of simulation parameters; 2) simulation results for G-set; 3) reasoning for parameter selection; 4) results and discussion for CIM-SFC on G-set; 5) similarities and differences between CIM and SBM algorithms; 6) optical implementation of CIM-SFC and are all part of the specification and are incorporated herein by reference. Appendix G discloses cited references.

### FIELD

The disclosure relates to a system and method for solving combinatorial optimization problems using quantum inspired optimization processes.

### BACKGROUND

Combinatorial optimization problems are ubiquitous in modern science, engineering, medicine, and business and these problems are often NP-hard, so the runtime on classical digital computers is expected to scale exponentially. A representative example for NP-hard combinatorial optimization problems is the non-planar Ising model. Special purpose quantum hardware devices have been developed for finding a solution of Ising problems more efficiently than standard heuristic approaches. One example is a quantum annealing (QA) device which exploits the adiabatic evolution of pure state vectors by a time-dependent Hamiltonian. Another example is the coherent Ising machine (CIM) which exploits the quantum-to-classical transition of mixed state density operators in a quantum oscillator network. The performance comparison between the QA and the CIM for various Ising models such as complete graphs, dense graphs, and sparse graphs has been reported. Furthermore, the theoretical performance comparison between the ideal gate-model quantum computers implementing either Grover's search algorithm or the adiabatic quantum computing algorithm, and the CIM has been performed. Even though the CIM with all-to-all coupling among spins can be effective, the use of an external FPGA circuit as well as an analog-to-digital converter (ADC) and a digital-to-analog converter (DAC) invites a large amount of energy dissipation and also introduces a potential bottleneck for high speed operations.

It has been recognized that the standard linear coupling scheme of the CIM suffers from the amplitude heterogeneity among constituent quantum oscillators. Because of this amplitude heterogeneity, the Ising Hamiltonian will be incorrectly mapped to the network loss leading to unsuccessful operation, especially in frustrated spin systems. An error-correcting feedback scheme has been developed to resolve this problem, which makes the CIM competitive in solution accuracy with state of the art heuristics such as break-out local search (BLS).

### Semi-Classical Model for Error Correction Feedback

There are several mutual coupling and error correction feedback schemes for CIM. In order to simplify this argument, a semi-classical deterministic picture is used. The semi-classical model is an approximate theory for the following fictitious machine. At an initial time t=0, each signal pulse field is prepared in a vacuum state as shown in FIG. 1A. When the pump fields p and pi (shown in FIG. 1C) are switched on at t≥0, a vacuum field incident on the extraction beam splitter BSₑ from an open port is squeezed/anti-squeezed by a phase sensitive amplifier (PSA) 102 in this ODL-CIM, as shown in FIG. 1C. That is, the vacuum fluctuation in the in-phase component \tilde{X}=½ (â+â^{†}) is deamplified by a factor of 1/G, while the vacuum fluctuation in the quadrature-phase component \tilde{P}=½i (â+â^{†}) is amplified by a factor of G. Similarly, the vacuum fluctuations incident on the OPO pulse field due to any linear loss of the cavity are all squeezed by respective PSA 102. Moreover, the pump field and feedback injection field fluctuations along the in-phase component are also deamplified by respective PSA 102 (as shown in FIG. 1C).

The truncated Wigner stochastic differential equation (W-SDE) for such a quantum-optic CIM with squeezed reservoirs has been derived and studied. This particular CIM achieves a maximum quantum correlation among OPO pulse fields along the in-phase component and achieves a maximum success probability. This is because the quantum correlation among OPO pulse fields is formed by the mutual coupling of the vacuum-fluctuations of OPO pulse fields without injection of uncorrelated fresh reservoir noise in such a system. The following semi-classical model is considered as an approximate theory of the above W-SDE in the limit of a large deamplification factor (G»1). A full quantum description of a more realistic CIM with optical error correction circuits (without reservoir engineering) is discussed below.

In order to overcome the problem of amplitude heterogeneity in the CIM, the addition of an auxiliary variable for error detection and correction has been proposed. This system has been studied as a modification of the measurement feedback CIM. The spin variable (signal pulse amplitude) xᵢ and auxiliary variable (error pulse amplitude) eᵢ obey the following deterministic equations:

$$\begin{matrix}\frac{{dx}_{i}}{dt} = - {x}_{i}^{3} + ( p - 1 ) {x}_{i} - {e}_{i} {Σ}_{j} ξ {J}_{ij} {x}_{j} and & ( 1 ) \\ \frac{{de}_{i}}{dt} = - β {e}_{i} ( {x}_{i}^{2} - α ) & ( 2 )\end{matrix}$$

where Jᵢⱼ is the Ising coupling matrix, α, β and β are system parameters and ξ is a normalizing constant for Jᵢⱼ (see Appendix A for parameter selection). In many cases, the parameters may be modulated over time to achieve better performance (see Appendix C). To use this system as an Ising solver, the spin configuration σᵢ=sign (xᵢ) as a possible solution to the corresponding Ising problem. Even though noise is neglected in the above equation, the initial xᵢ amplitude is chosen randomly to create a diverse set of possible trajectories. This system of equations may be known as CIM-CAC (CIM with chaotic amplitude control). The term “chaotic” is used because CIM-CAC displays chaotic behavior (as discussed below). CIM-CAC may either refer to the above system of deterministic differential equations when integrated as a digital algorithm, or an optical CIM that emulates the above equations.

The CIM-CAC equations can be modified as follows:

$$\begin{matrix}{z}_{i} = {e}_{i} {Σ}_{j} ξ {J}_{ij} {x}_{j} & ( 3 ) \\ \frac{{dx}_{i}}{dt} = - {x}_{i}^{3} + ( p - 1 ) {x}_{i} - {z}_{i} & ( 4 ) \\ \frac{{de}_{i}}{dt} = - β {e}_{i} ( {z}_{i}^{2} - α ) & ( 5 )\end{matrix}$$

which we will call CIM-CFC (CIM with chaotic feedback control). A difference between eqs. (2) and (5) is that the time evolution of the error variable eᵢ monitors the feedback signal zᵢ, rather than the internal amplitude xᵢ. This new equation gives very similar dynamics to CIM-CAC which can be understood by observing that CIM-CAC and CIM-CFC have nearly identical fixed points. The motivation behind analyzing CIM-CFC in addition to CIM-CAC is to try to get a better understanding of how these systems work. Additionally, CIM-CFC may have slightly simpler dynamics which makes it easier to numerically integrate.

There is also another system that has a very different set of equations:

$$\begin{matrix}{z}_{i} = {Σ}_{j} ξ {J}_{ij} {x}_{j} & ( 6 ) \\ \frac{{dx}_{i}}{dt} = - {x}_{i}^{3} + ( p - 1 ) {x}_{i} - f ( {cz}_{i} ) - k ( {z}_{i} - {e}_{i} ) & ( 7 ) \\ \frac{{de}_{i}}{dt} = - β ( {e}_{i} - {z}_{i} ) & ( 8 )\end{matrix}$$

The non-linear function f is a sigmoid-like function such as f(z)=tanh(z), and p, k, c and β are system parameters (See Appendix A for parameter selection). The significance of this new feedback system is that the differential equation for the error signal eᵢ is now linear in the “mutual coupling signal” zᵢ. Additionally, z; is calculated simply as EⱼξJᵢⱼxⱼ without the additional factor eᵢ as in equation (6). This means that the only nonlinear elements in this system are the gain saturation term −xᵢ³ and the nonlinear function f. For this system, it is assumed that f(z)=tanh(z), however other functions can also be used. In the above system, the two essential aspects of CIM-CAC and CIM-CFC are separated into two different terms. The term f(czᵢ) realizes mutual coupling while passively fixing the problem of amplitude heterogeneity, while the term k(zᵢ-eᵢ) introduces the error signal eᵢ which helps destabilize local minima. This system may be known as CIM-SFC (CIM with separated feedback control).

Another significant difference of CIM-SFC (eqs. (6), (7) and (8)) compared to CIM-CAC and CIM-CFC (eqs. (1)-(5)) is that the auxiliary variables eᵢ in CIM-SFC have a very different meaning. In CIM-CAC and CIM-CFC, eᵢ is meant to be a strictly positive number that varies exponentially and modulates the mutual coupling term. In CIM-SFC eᵢ is now a variable that stores sign information and takes the same range of values as the mutual coupling signal zᵢ. The error signal eᵢ can essentially be thought of as a low pass filter on zᵢ, and the term k(eᵢ-zᵢ) can be thought of as a high pass filter on zᵢ (in other words k(eᵢ-zᵢ) only registers sharp changes in zᵢ). A way to understand the similarities and differences between CIM-SFC, CIM-CAC and CIM-CFC is to look at the fixed points. In CIM-CAC and CIM-CFC, the fixed points are of the form:

$$\begin{matrix}{x}_{i} = {λ}_{1} {σ}_{i} & ( 9 ) \\ {e}_{i} = {λ}_{2} \frac{1}{{h}_{1} {σ}_{i}} & ( 10 )\end{matrix}$$

$$with$$

$${h}_{i} = {Σ}_{j} ξ {J}_{ij} {σ}_{j} \qquad ( 11 )$$

Here σᵢ is a spin configuration corresponding to a local minimum of the Ising Hamiltonian. Δ₁ and Δ₂ are constants that depend on the system parameters. In CIM-SFC, the fixed points are in general very complicated and hard to write explicitly. However, if the limit of c»1, the fixed points will take the form:

$$\begin{matrix}{x}_{i} = {d}^{- 1} ( 1 ) {ρ}_{i} & ( 12 ) \\ {e}_{i} = {d}^{- 1} ( 1 ) {h}_{i} & ( 13 )\end{matrix}$$

$$with$$

$$d ( x ) = - {x}^{3} + ( p - 1 ) x \qquad ( 14 )$$

Again, σᵢ is a spin configuration corresponding to a local minimum. This formula is only valid if f(cz) is an odd function that takes on the value+1 for cz»1 and −1 for cz»−1. This is why it is important that an appropriate function f is chosen.

The important difference between the fixed points of these two types of systems is that in CIM-CAC and CIM-CFC, the error signal is

$$\vert {e}_{i} \vert ∝ = \frac{1}{\vert {h}_{i} \vert}$$

whereas in CIM-SFC, the error signal is |eᵢ|∝|hᵢ|. As discussed below, the difference allows CIM-SFC to be more robust to quantum noise from reservoirs and pump sources.

### BRIEF DESCRIPTION OF THE DRAWINGS

FIG. 1A illustrates a vacuum state and a squeezed vacuum state;

FIG. 1B illustrates a coherent state and a squeezed coherent state;

FIG. 1C illustrates a coherent Ising machine;

FIG. 2A illustrates operational powers of active photonic devices in 100 GHz CIM;

FIG. 2B illustrates energy to solution in three subsystems in a CIM;

FIGS. 2C-E illustrate the trajectories of OPO amplitudes in three different CIMs;

FIG. 3 illustrates mutual coupling field and injection feedback field for four different feedback systems;

FIG. 4 illustrates the signal pulse amplitude correlations at different evolution times;

FIG. 5 illustrates the signal pulse trajectories with fixed and modulated system parameters;

FIG. 6A illustrates optical error correction circuits for a novel CIM;

FIG. 6B illustrates a pump pulse factory that provides pulses to the main cavity shown in FIG. 1C;

FIG. 6C illustrates a novel CIM with optical feedback that includes the main cavity shown in FIG. 1C, the optical error correction circuits in FIG. 6A and the pump pulse factory shown in FIG. 6B;

FIG. 7 illustrates a success probability versus saturation parameter for CIM-SFC and CIM-CFC;

FIG. 8 illustrates an energy cost to solution in Joules for CIM-SFC and CIM-CFC;

FIG. 9 illustrates an estimated energy cost to solution of optical and GPU implementations of CIM-CAC versus problem size;

FIG. 10 illustrates TTSs for CIM-CAC, CIM-CFC and CIM-SFC;

FIG. 11 illustrates TTSs for CIM-SFC and NMFA versus problem size;

FIG. 12 illustrates the required number of matrix vector multiplications for CIM-CAC, CIM-CFC and CIM-SFC versus dSBM;

FIG. 13 illustrates the TTS for CIM-CAC, CIM-CFC and CIM-SFC and dSBM;

FIG. 14 illustrates a number of unsolved instances for CIM-CAC and dSBM;

FIG. 15 illustrates a success probability of CIM-CAC;

FIG. 16 illustrates the performance of CIM-CAC with respect to problem size for different parameters;

Table 1 illustrates the success probability and TTS of CIM-CAC, CIM-CFC and dSBM on G-set graphs; and

FIG. 17 illustrates an optical implementation of the CIM-SFC.

### DETAILED DESCRIPTION OF ONE OR MORE EMBODIMENTS

The disclosure is related to a coherent Ising machine (CIM) that has optical feedback correction that includes the combination of a main cavity, optical error correction circuits, and a pulse pump factory that may be used for solving combinatorial optimization problems and it is in this context that the disclosure will be described. It will be appreciated, however, that system and method can be implemented using other variations on the elements disclosed below that are within the scope of the disclosure.

The novel CIM architecture disclosed herein has error correction that is implemented optically. In this architecture, the computationally intensive matrix-vector-multiplication (MVM) and a nonlinear feedback function are implemented by phase sensitive (degenerate) optical parametric amplifiers. These are essentially the same device used for the main cavity optical parametric oscillator (OPO). This novel CIM architecture can potentially be implemented monolithically on future photonic integrated circuits using thin film LiNbO₃ platforms. The network of open dissipative quantum oscillators with optical error correction circuits is not only promising as a future hardware platform, but also as a quantum inspired algorithm because of its simple and efficient theoretical description. In order to numerically simulate the time evolution of a N-qubit quantum system, 2^{N} complex number amplitudes may be used. For a quantum oscillator network, however, various phase space techniques of quantum optics have been developed. The complete description of a network of quantum oscillators is now possible by N (or 2^{N}) sets of stochastic differential equations (SDE) based on either positive-P, truncated-Wigner, or truncated Husimi representations of the master equations. These SDEs can be used as heuristic algorithms on modern digital platforms. To completely described a network of low-Q quantum oscillators, a discrete map technique using a Gaussian quantum model is available, which is also computationally efficient. Similarly, the network of dissipation-less quantum oscillators with adiabatic Hamiltonian modulation is described by a set of N deterministic equations, which is also used as a heuristic algorithm on modern digital platform. This heuristic algorithm is also named as simulated bifurcation machine (SBM), a variant of which is disclosed below. It is interesting to compare these two quantum inspired algorithms, however, the version of SBM discussed below (dSBM) may not necessarily be a true unitary system, as dissipation is added artificially by the use of inelastic walls in order to improve the performance of the algorithm. Since both algorithms have matrix-vector-multiplication (MVM) as the computational bottleneck when simulated on a digital computer, the number of MVM is a good metric for performance comparison. As set forth below, both types of systems may have similar performance in most cases, except graph types with greatly varying edges per node where the SBM struggles consistently.

### Numerical Simulation of CIM-CAC, CIM-CFC and CIM-SFC

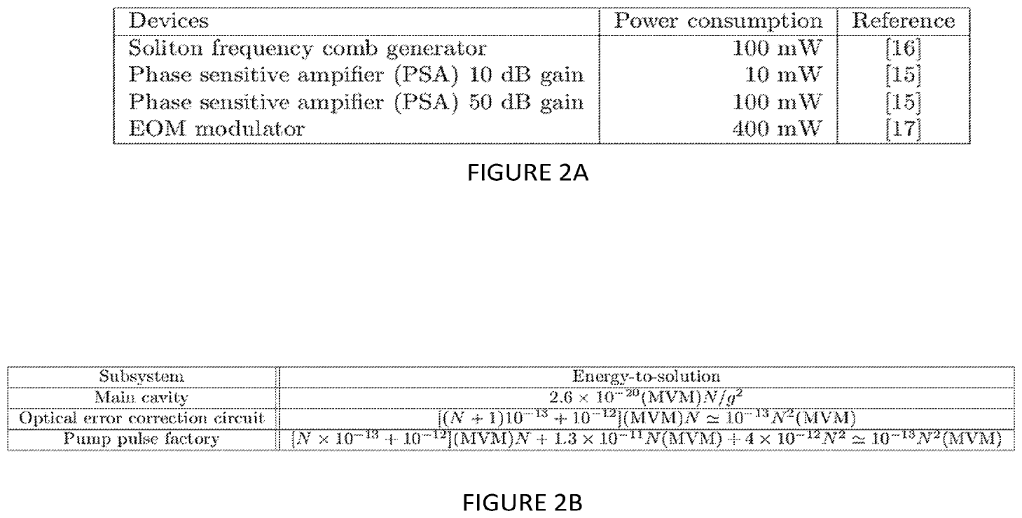

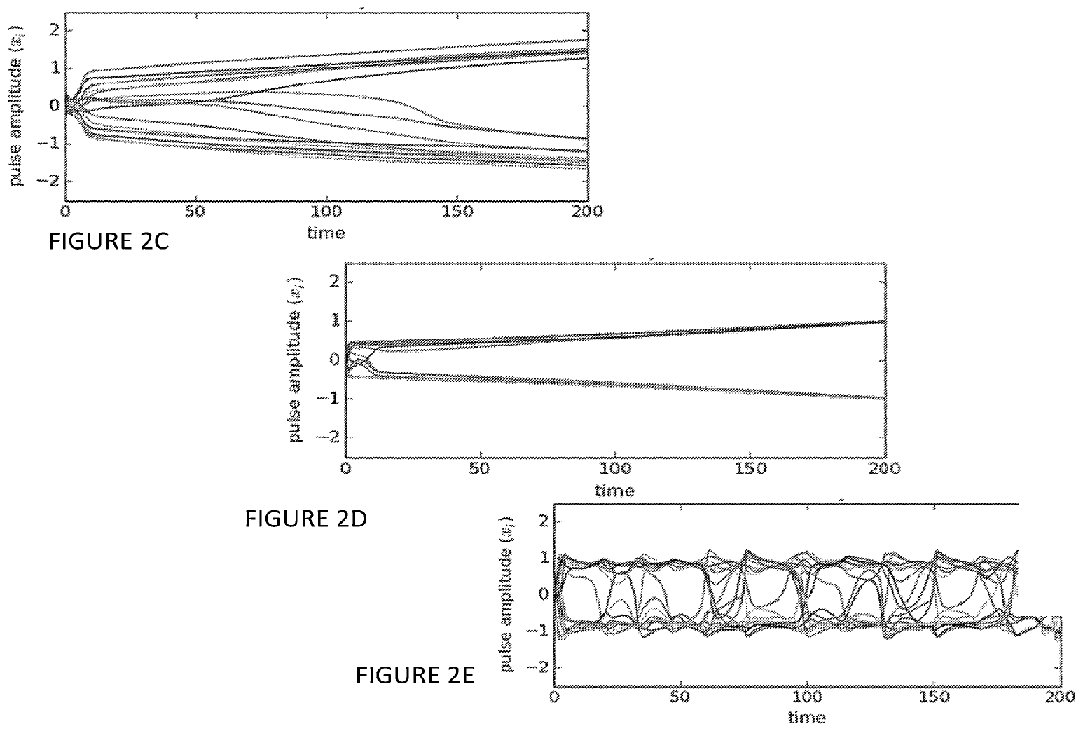

One known CIM architecture employed simple linear feedback without using an error detection/correction mechanism so that the feedback term in eq. (1) is simply ΣⱼξJᵢⱼxⱼ. In this case, the Ising Hamiltonian cannot be properly mapped on the network loss due to OPO amplitude heterogeneity, specifically for frustrated spin systems, as shown in FIG. 2C. Such a CIM often does not find a ground state of the Ising Hamiltonian but instead picks up a lowest-energy eigenstate of the coupling (Jacobian) matrix [Jᵢⱼ]. This undesired operation is caused by a system's formation of heterogenous amplitudes. This technical problem can be fixed partially by introducing a nonlinear filter function for the feedback pulse such as tanh (ΣⱼξJᵢⱼxⱼ). Then the CIM system can achieve the homogeneous OPO amplitudes, at least well above threshold, as shown in FIG. 2D and satisfy the proper mapping condition toward the end of the system's trajectory. However, such nonlinear filtering alone may not be powerful enough to keep the machine from being trapped in numerous local minima. As the problem size N increases, NP-Hard Ising problems are expected to have an exponentially increasing number of local minima, so a system that gets trapped too easily will be ineffective.

In order to destabilize the attractors caused by local minima and let the machine continue to search for a true ground state, an error detection/correction variable can be introduced expressed by eq. (2) or (5). By destabilizing local minima, it will also be inevitable that a ground state will be unstable as well. Although this is undesirable, the CIM machine can visit many local minima and then find which one has the lowest energy afterwards. Alternatively, the system parameters may be modulated and the system will have a high probability of staying in a ground state toward the end of the trajectory as discussed below.

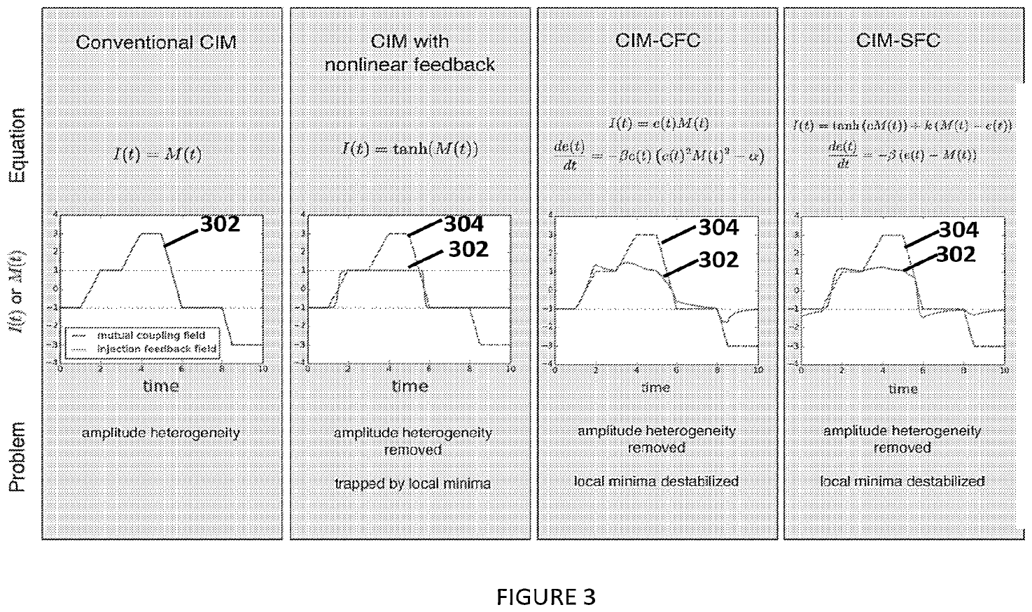

The addition of another N degrees of freedom allows the machine to visit a local minimum but then escape and continue to explore nearby states, something which is not possible with a conventional CIM algorithm. As shown in FIG. 2E, the trajectory of a CIM with error correction variables will not reach equilibrium but continue to explore many states. Conversely, the systems in FIGS. 2C and 2D, which do not have an error correction variable (eᵢ), often will quickly converge on a fixed point corresponding to a high energy excited state of the Ising Hamiltonian. The above issues can be resolved using error correction schemes including CIM-CFC and CIM-SFC. Even though CIM-CFC and CIM-SFC are described by very different equations, the two systems were originally conceived through a similar concept. To understand why CIM-CFC and CIM-SFC are similar, it is useful to consider these systems by introducing a “mutual coupling signal” Mᵢ(t)=ΣJᵢⱼxⱼ(t) and the “injection feedback signal” I; (t). These signals, for both CIM-CFC and CIM-SFC in the form

$$\begin{matrix}{M}_{i} ( t ) = {h}_{i} = {Σ}_{j} ξ {J}_{ij} {x}_{j} ( t ) & ( 15 ) \\ \frac{{dx}_{i}}{dt} = - {x}_{i}^{3} + ( p - 1 ) {x}_{i} - {I}_{i} ( t ) & ( 16 )\end{matrix}$$

where Iᵢ(t) depends on the time evolution of Mᵢ(t). FIG. 3 shows how Iᵢ(t) 302 varies with respect to the mutual coupling field Mᵢ(t) 304 for four different feedback schemes. The similarity between CIM-CFC and CIM-SFC is as follows: if the mutual coupling field Mᵢ(t) 304 stays constant for a certain period of time, then the injection feedback field Iᵢ(t) 302 will converge on the value given by sign (Mᵢ(t)). However, if Mᵢ(t) 304 varies sharply, then Iᵢ(t) 302 will deviate from it's steady state values: +1/−1. This small deviation is effective to trigger destabilization when the system is near a local minima, which keeps the machine exploring new spin configurations.

Although CIM-CFC and CIM-SFC were conceived based on the same principle, the dynamics of two systems may differ from each other. In particular, CIM-CFC (and also CIM-CAC) almost always features chaotic dynamics as the trajectory is very sensitive to initial conditions. In the case of CIM-SFC, the trajectory will often immediately fall into a stable periodic orbit unless the parameters are dynamically modulated.

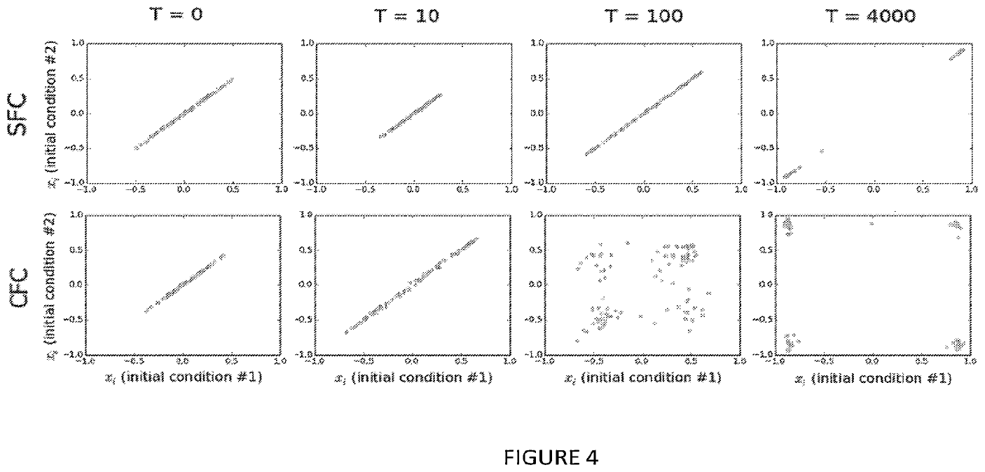

To demonstrate this difference, FIG. 4 shows the correlation of pulse amplitudes between two initial conditions that are very close to each other. An initial condition for the pulse amplitude #1 (plotted in x-axis) is chosen from a zero-mean Gaussian with standard deviation 0.25, and the other initial condition for the same pulse #2 (plotted in y-axis) is equal to that of #1 plus a small amount of noise (standard deviation 0.01). FIG. 4 shows the correlation of all 100 pulse amplitudes between the two initial conditions for a Sherrington-Kirkpatrick (SK) spin glass instance fₒ problem size N=100. In CIM-SFC (first row), the correlation is kept even after 4000 time steps (round trips), which means two initial conditions follow a nearly identical trajectory. However, in CIM-CFC (second row), the xᵢ variables become uncorrelated after around 100 time steps even though the initial conditions of two trajectories are very close. This demonstrates qualitatively that CIM-CFC is very sensitive to the initial condition while CIM-SFC is not.

This pattern tends to hold when different parameters and initial conditions are used. However, although CIM-SFC stays correlated in most cases, there are some regions of system parameters and initial conditions where the two trajectories diverge. This means although CIM-SFC is less sensitive to initial conditions than CIM-CFC, there are still likely some chaotic dynamics that occur during the search, especially when the parameters are modulated.

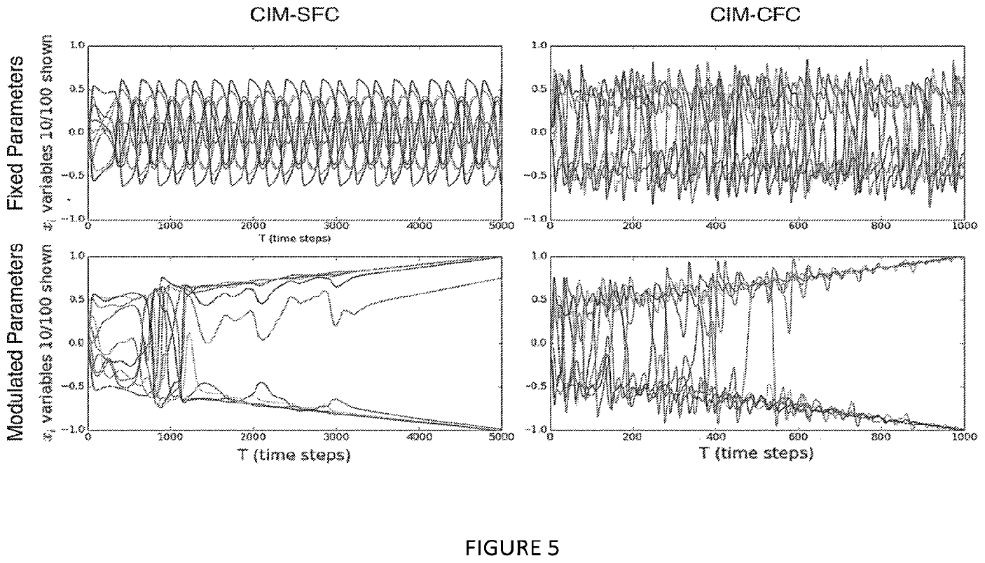

Another way to see the difference in dynamics qualitatively is by simply looking at the trajectories. FIG. 5 shows example trajectories of both systems (10 out of 100 xᵢ variables are shown for the above SK problem) with fixed system parameters and linearly modulated system parameters. When the parameters are fixed, the difference between the two systems is apparent. CIM-SFC will quickly become trapped in a stable periodic attractor while CIM-CFC will continue to search in an unpredictable manner. For this reason it is necessary that the parameters are slowly modulated in CIM-SFC in order for the system to find a ground state. CIM-CFC and CIM-CAC are capable of finding ground states with fixed parameters. However, modulation of the system parameters greatly improves the performance of CIM-CFC and CIM-CAC (see Appendix C for details).

In the lower left panel in FIG. 5, the parameters c and p of CIM-SFC are linearly increased from low to high values (p ranges from −1 to +1 and c ranges from 1 to 3). As shown, as the parameters change, the system may jump from one attractor to another and eventually end up in a fixed point/local minimum. By linearly increasing the parameters c and p from a low to high value in CIM-SFC, the nonlinear term tanh (czᵢ) is transitioned from a “soft spin” mode where the nonlinear coupling term has a continuous range of values between −1 and 1 to a “discrete” mode where tanh (czᵢ) will mostly take on the values +1 or −1. This transition appears to be important for the CIM-SFC to function properly.

For most fixed parameters CIM-SFC quickly approaches a periodic or fixed point attractor as in FIG. 5, however as mentioned earlier it is likely that for some specific values of c and p, CIM-SFC will feature chaotic dynamics similar to CIM-CFC. It has been shown that chaotic dynamics are observed when solving hard optimization problems efficiently using a deterministic system and in the simulated bifurcation machine.

Implementation of CIM with Optical Error Correction Circuits

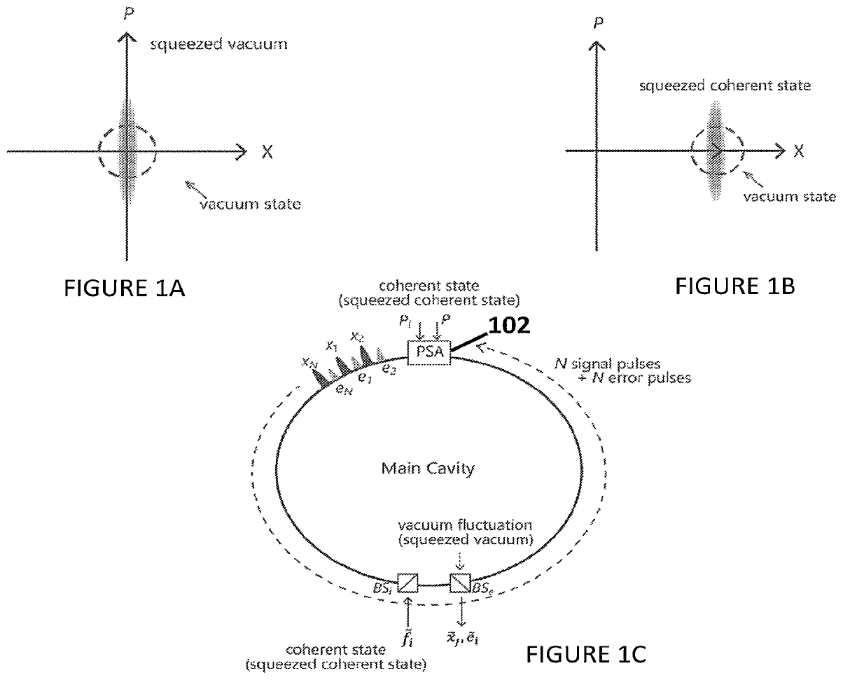

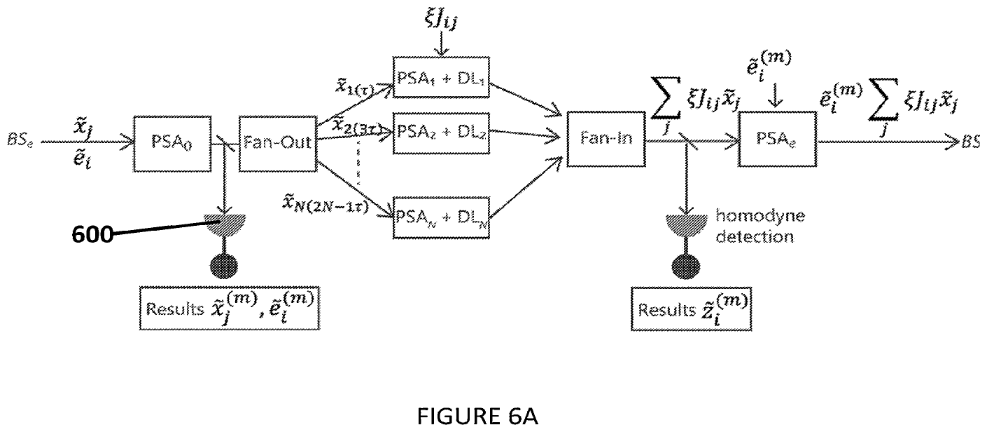

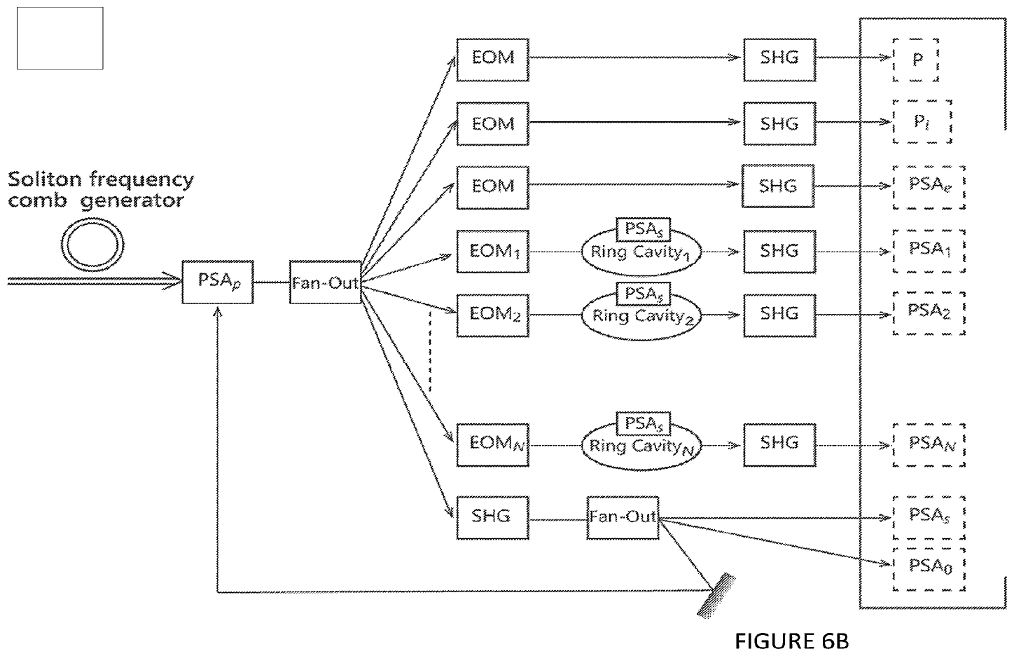

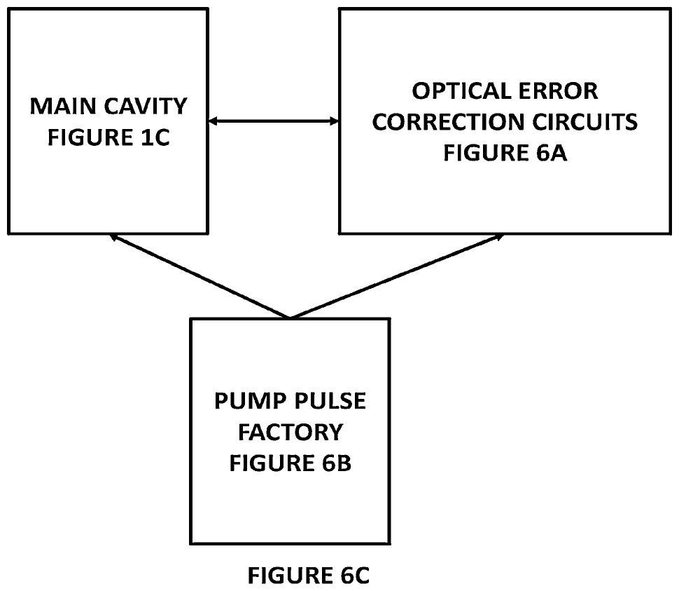

FIGS. 6A and 6B, together with FIG. 1C, shows a physical setup for CIM-CAC and CIM-CFC with optical error correction circuits. The overall architecture is shown in FIG. 6C. In the novel architecture, a main ring cavity (shown in FIG. 1C) stores both signal pulses with normalized amplitude x; and error pulses with normalized amplitude eᵢ, where i=1, 2, . . . ,N. The signal pulses start from vacuum states |O [symbol] ₁|0 [symbol] ₂ . . . |O [symbol] _{N} and are amplified (or deamplified) along the X-coordinate by positive (or negative) pump rate p.

The error pulses start from a coherent state |α [symbol] |α [symbol] ₂ . . . |α [symbol] _{N} with α>0 and are amplified (or deamplified) along the X-coordinate by the pump rate p′ as descri bed below. The squared amplitude of the error pulses is kept small (eᵢ²<1) compared to the saturation level of the main cavity OPO. This means that the error pulses are manipulated in a linear amplifier/deamplifier regime while the signal pulses are controlled in both a linear amplifier/deamplifier regime (xᵢ²<1) and a nonlinear oscillator regime (xᵢ²>1).

An extraction beamsplitter (BSe shown in FIG. 1C picks off partial waves of the signal and error pulses which are amplified by a noise-free phase sensitive amplifier (PSA0 as shown in FIG. 6A. PSA0 amplifies the signal and error pulses to a classical level without introducing additional noise. The extracted amplitudes \tilde{x}ᵢ and \tilde{e}ᵢ suffer from the signal-to-noise ratio degradation due to the vacuum noise incident on BS_{c}. However, they are amplified by a high-gain noise-free phase sensitive amplifier PSA0 to classical levels, so no further signal-to-noise ratio degradation occurs even with large linear loss in optical error correction circuits.

A small part of PSA0 output is sent to an optical homodyne detector 600, which measures the extracted signal and error pulses with amplitudes \tilde{x}ᵢ and \tilde{e}ᵢ. The measurement error of the homodyne detection is determined solely by the reflectivity of BS_{c} and the vacuum fluctuation incident on BS_{c} (as described above). FIG. 6A shows the output of the fan-out circuit at different time instances t=τ; 3τ; 5τ; . . . separated by a signal pulse to signal pulse interval of 2τ.

For instance, the signal pulse (\tilde{x}ⱼ) is first input into PSAⱼ and then sent to optical delay line DLⱼ with a delay time of (2N−2j+1)τ. The phase sensitive gain/loss of PSAⱼ is set to \sqrt{Gj}=ξJᵢⱼ so that the amplified/deamplified signal pulse that arrives in front of the fan-in circuit at time t=2Nτ is equal to ξJᵢⱼ\tilde{x}ⱼ. Therefore the fan-in circuit will output a pulse with the desired amplitude of EⱼξJᵢⱼ\tilde{x}ⱼ. Suppose PSAⱼ has a phase sensitive linear gain/loss of 10 dB, then the system can implement an arbitrary Ising coupling of range 10⁻²<|ξJᵢⱼ|Jᵢⱼ<1.

Next, the output of the fan-in circuit is input into another phase sensitive amplifier PSAe which amplifies with a factor of \sqrt{Gₑ}=\tilde{e}ᵢ. This is achieved by modulating the pump power to PSAe based on the measurement result for \tilde{e}ᵢ. Finally, the output of PSAe is injected back into signal pulse (xᵢ) of the main cavity via signal BSᵢ shown in FIG. 6A to the beamsplitter BSᵢ shown in FIG. 1C. The extraction beamsplitter BS_{c} outputs not only signal pulses but also error pulses which are used only for homodyne detection. Therefore, when using the CIM, the pump power is switched off PSA₀ for the error pulses and deamplify the residual error pulses by PSA₁, PSA₂, . . . , PSA_{N}, PSAₑ. In this way, the CIM avoids any spurious injection of the error pulse back into the main cavity. The dynamics of the error pulse are governed solely by the pump power pᵢ to the main cavity PSA, which is set to satisfy pᵢ-1=β(α−\tilde{x}ᵢ²) or pᵢ−1=β(α−zᵢ²).

One advantage of this optical implementation of CIM-CAC and CIM-CFC is that only one type of active device, a noise-free phase sensitive (degenerate optical parametric) amplifier, is used and all the other elements are passive devices. This fact may allow for onchip monolithic integration of the CIM system and also low-energy dissipation in the computational unit which will be discussed below. A similar optical implementation of CIM-SFC is shown in Appendix F.

FIG. 6(b) shows a pump pulse factory which provides the second harmonic generation (SHG) pulses to the main cavity PSA, post-amplifier PSA₀, delay line amplifiers PSA₁, PSA₂, . . . . PSA_{N} and exit amplifier PSA_{c}. The purpose of this pump pulse factory is to reduce the use of EOM modulators, which is a most energy-hungry device in the entire CIM. A soliton frequency comb generator produces a pulse train at 100 GHz repetition frequency and at 1.56 μm wavelength. Before it is split into many branches, the pulse train is amplified by a pump amplifier PSAₚ. N storage ring cavities continuously produce the pump pulses for PSA₁, PSA₂, . . . . PSA_{N} in order to implement the matrix-vector-multiplication ΣξJᵢⱼ\tilde{x}ⱼ. For this purpose, the pulses stored in the i-th ring cavity acquire the appropriate amplitudes to realize the gain \sqrt{Gᵢⱼ}=ξJᵢⱼ. The time duration to use N EOM arrays is only one round trip duration of the ring cavity, i.e. N×10 (psec). The out-coupling loss of the storage ring cavities is compensated for by the linear gain of the internal PSAs. The pump pulses for PSAₚ, PSAₛ and PSA₀ have constant amplitudes, so they are driven directly by the PSAₚ output. The pump pulses P and Pᵢ for the signal and error pulses in the main cavity, as well as the exit PSA_{c}, must be modulated during the entire computation time.

Another detail that needs to be accounted for when considering an optical implementation, is the calculation of the Ising energy. In a digital simulation used to generate the results in this disclosure, the Ising energy is calculated every time step (round trip) and the smallest energy obtained is used as the result of the computation. This means, in an optical implementation, the system measures the \tilde{x}ᵢ amplitude every round trip and calculate the Ising energy using, for instance, an external ADC/FPGA circuit. This would defeat the purpose of using optics since the digital circuit in the ADC/FPGA would then become a bottleneck for time and energy consumption. It was discovered, however, that with the proper parameter modulation as shown in FIG. 5 it is possible to only use the final state of the system for the result and still have high success probability. For the results set forth below on 800-spin Ising instances (SK model), it was calculated how often a successful trajectory is in the ground spin configuration after the final time step. For CIM-SFC, in 100% of the 7401 successful trajectories the final spin configuration was in the ground state. In other words, if CIM-SFC visits the ground state at any point during the trajectory, then it will also be in the ground state at the end of the trajectory. On the other hand, for CIM-CFC and CIM-CAC, this was true only in 75% of the time and 48% of the time, respectively. The difference between the three systems may be a result of both the intrinsic dynamics and the parameters used.

This demonstrates that in a CIM with optical error correction, the system can simply digitize the final measurement result of x; after many round trips to get the computational result, and still have a high success probability. In the case of CIM-CFC and CIM-CAC it might be beneficial to read the spin configuration multiple times during the last few round trips, since the machine usually visits the ground state close to the end of the trajectory even if it does not stay there.

### Quantum Noise Analysis and Energy to Solution

The CIM discloses uses analog optical devices and thus it is important to study how much the noise from physical systems (in this case quantum noise from pump sources and external reservoirs) will degrade the performance using quantum models based on the optical implementation.

In the proposed optical implementation for CIM-CAC, the real number signal pulse amplitude μᵢ (in unit of photon amplitude) obeys the following truncated-Wigner SDE [22; 23]:

$$\frac{d}{dt} {μ}_{i} = ( p - 1 ) {μ}_{i} - {g}^{2} {μ}_{i}^{3} + {\tilde{v}}_{i} {Σ}_{j} ξ {J}_{ij} {\tilde{μ}}_{j} + {n}_{i} \qquad ( 17 )$$

where the term pμᵢ represents the parametric linear gain and the term—μᵢ. represents the linear loss rate. This includes cavity background loss and extraction/injection beam splitter loss for mutual coupling and error correction. The nonlinear term g²μᵢ³ represents a gain saturation (or back conversion from signal to pump), where g is the saturation parameter. The saturation photon number is given by 1/g2, which is equal to an average photon number of a solitary OPO at a pump rate p=2 (two times above threshold). Jᵢⱼ is the (I, j) element of the N×N Ising coupling matrix as described above. The time t is normalized by a linear loss rate, so the signal amplitude decays by a factor of 1/e at time t=1. \tilde{μ}ⱼ=μⱼ+Δμⱼ and \tilde{v}ᵢ=vᵢ+Δvᵢ are the inferred amplitudes for the signal pulse and error pulse respectively, and Δμⱼ and Δvᵢ represent additional noise governed by vacuum fluctuations incident on the extraction beam splitter. They are characterized by

$$\sqrt{\frac{1 - {R}_{B}}{4 {R}_{B}}} ω ,$$

where R_{B} is the reflectivity of the extraction beam splitter and ω is a zero-mean Gaussian random variable with a variance of one. nᵢ is the noise injected from external reservoirs and pump sources. [22; 23] It is characterized by the two time correlation function:

$$〈 {n}_{i} ( t ) {n}_{i} ( {t}^{′} ) 〉 = ( \frac{1}{2} + {g}^{2} {μ}_{i}^{2} ) δ ( t - {t}^{′} ) .$$

The above assumes that the external reservoirs are in vacuum states and that the pump fields are in coherent states.

The real number error pulse amplitude vᵢ (in unit of photon amplitude) is governed by

$$\frac{d}{dt} {v}_{i} = ( {p}_{i}^{′} - 1 ) {v}_{i} + {m}_{i} \qquad ( 18 )$$

wherein the correlation function for the noise term is given by [symbol] mᵢ(t)mᵢ(t′) [symbol] =½δ(t−t′). A pump rate p′ᵢ for the error pulse is determined by the inferred signal pulse amplitude \tilde{x}ᵢ=g\tilde{μ}ᵢ normalized by the saturation parameter, p′ᵢ−1=β(α−\tilde{x}ᵢ²) (19).

The error pulses start from coherent states |γ [symbol] ₁, |γ [symbol] ₂ . . . |γ [symbol] _{N} for some positive real number 1/g>>γ>0. The absence of a gain saturation term in eq. (18) means that the error pulses are always pumped at below threshold. Nevertheless, the error pulses represent exponentially varying amplitudes. The parameter β governs a time constant for error correction dynamics and α is the squared target amplitude. This feedback model stabilizes the squared signal pulse amplitude \tilde{x}ᵢ²=g²\tilde{μ}ᵢ² to α through an exponentially varying error pulse amplitude eᵢ=gvᵢ. Equations (17) and (18) are rewritten for the normalized amplitudes \tilde{x}ᵢ and \tilde{e}ᵢ as

$$\begin{matrix}\frac{d}{dt} {x}_{i} = ( p - 1 ) {x}_{i} - {x}_{i}^{3} + {\tilde{e}}_{i} {Σ}_{j} ξ {J}_{ij} {\tilde{x}}_{j} + {gn}_{i} and & ( 20 ) \\ \frac{d}{dt} {e}_{i} = ( {p}_{i}^{′} - 1 ) {e}_{i} + {gm}_{i} & ( 21 )\end{matrix}$$

which are nearly identical to eqs. (1) and (2) except for the noise terms.

CIM-CFC is also realized by the experimental setup shown in FIG. 6. In this case, the relevant truncated-Wigner SDE for the error pulse amplitude is still given by eq. (18) or (21) but the pump rate p′ᵢ should be modified to p′ᵢ−1=β(α−\tilde{z}ᵢ²) (22) with \tilde{z}ᵢ=ΣⱼξJᵢⱼ\tilde{x}ⱼ (23)

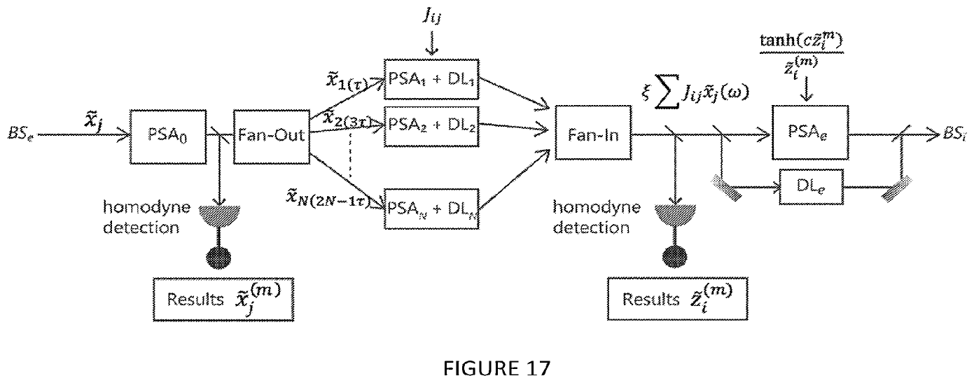

Lastly, CIM-SFC can also be realized by the experimental setup shown in Appendix F and FIG. 17). In this case, eqs. (20) and (21) should be modified as \tilde{z}ᵢ=ΣⱼξJᵢⱼ\tilde{x}ⱼ (24),

$$\begin{matrix}\frac{d}{dt} {x}_{i} = ( p - 1 ) {x}_{i} - {x}_{i}^{3} + k ( {\tilde{e}}_{i} - {\tilde{z}}_{i} ) - tanh ( c {\tilde{z}}_{i} ) + {gn}_{i} and & ( 25 ) \\ \frac{d}{dt} {e}_{i} = - β ( {e}_{i} - {\tilde{z}}_{i} ) + {gm}_{i} & ( 26 )\end{matrix}$$

In comparing the semi-classical nonlinear dynamical models of CIM-CAC, CIM-CFC and CIM-SFC, represented by eqs. (1)-(8), to the quantum nonlinear dynamical models (truncated-Wigner SDE), eqs. (20)-(26), the main difference is the absence or presence of vacuum noise and pump noise terms gnᵢ and gmᵢ. The other important difference is that \tilde{x}ᵢ and \tilde{e}ᵢ are inferred amplitudes with the vacuum noise contribution in the quantum model, whereas in the semi-classical model the amplitudes xᵢ and eᵢ can be reproduced without additional noise.

It is important to analyze the impact of quantum noise on the performance of CIM. As indicated in eqs. (20)-(26), the relative magnitude of quantum noise on the signal pulses and error pulses is governed by the saturation parameter g. When g increases, the ratio between the normalized pulse amplitudes (xᵢ, eᵢ) and normalized quantum noise amplitude (gnᵢ and gmᵢ) becomes smaller. Therefore, the CIM performance is expected to degrade as g increases. However, as g increases, the OPO threshold pump power decreases (see Figure C1 in [31]), which suggests the OPO energy cost to solution can be potentially reduced with increasing g.

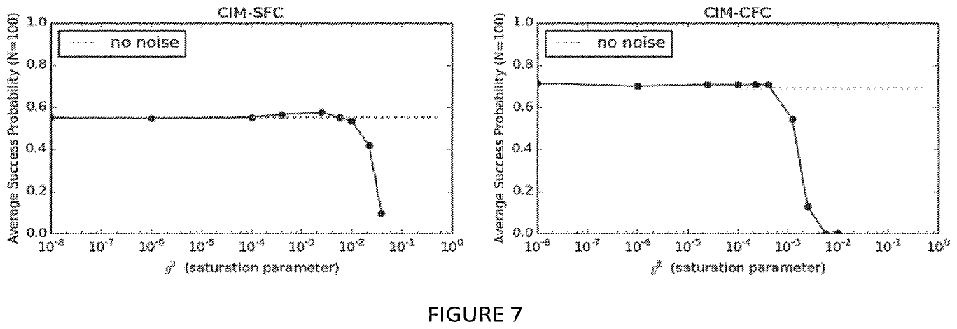

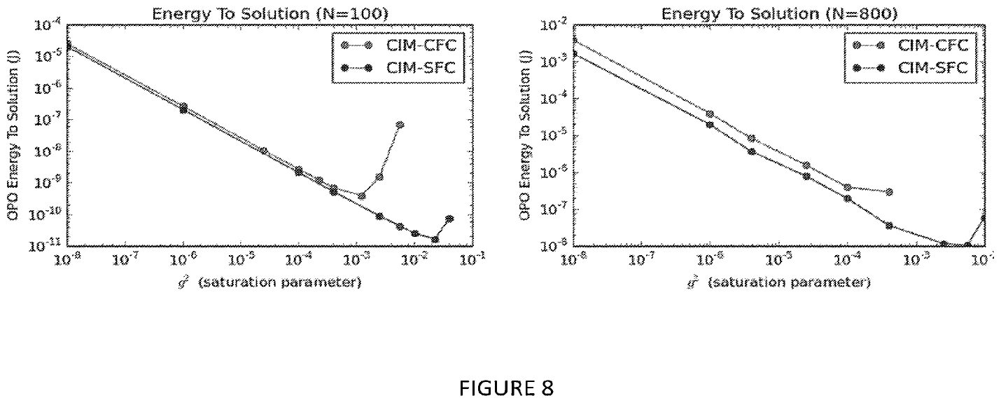

As shown in FIG. 7, the success probability Pₛ for N=100 Ising problems (SK model) vs. the saturation parameter g² is plotted. The reflectivity of the extraction beam splitter RB is assumed to be R_{B}=0.1. The success probability Pₛ is almost independent of the saturation parameter g² as far as g²≤10⁻⁴. However, as g² exceeds 10⁻³, the success probability drops quickly due to the decreased signal-to-quantum noise ratio, as mentioned above.

In FIG. 8, the energy cost to solution for Ising problems (SK model) with N=100 and N=800 are shown using only pump power to the main cavity PSA: Eₘₐᵢₙ=2hω(MVM)NΔt/g²(J) where MVM is the number of matrix-vector-multiplication steps to solution and Δt is a round trip time normalized by a signal lifetime (˜0.1). In FIG. 8, it can be seen that CIM-SFC is more robust to quantum noise compared to CIM-CFC, allowing use of a potentially larger value of g². This is to be expected due to the different role that the error variable eᵢ plays in each system. In CIM-CFC the feedback signal is calculated as \tilde{z}ᵢ=ΣⱼξJᵢⱼ\tilde{x}ⱼ(t) which is the main cause of performance degradation when quantum noise is increased. This is because, if the coherent excitation of et is large, then small errors in ΣⱼξJᵢⱼ\tilde{x}ⱼ(t) will be amplified, and conversely, if the coherent excitation of ΣⱼξJᵢⱼ\tilde{x}ᵢ(t) is large, then small errors in \tilde{e}ᵢ will be amplified. There are no such beat noise components in CIM-SFC. This is why CIM-SFC is more robust to quantum noise. Moreover, the nonlinear function tanh (c\tilde{z}ᵢ) can help to suppress quantum noise. Although they are not shown in FIG. 8, the results for CIM-CAC are nearly identical to the results for CIM-CFC.

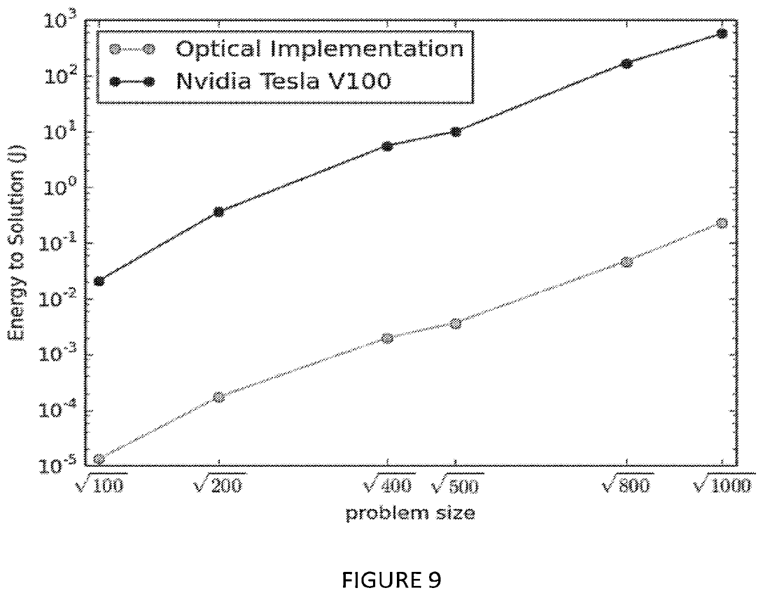

If the energy cost in optical error correction circuit and pump pulse factory (as described in FIG. 6) is included, the energy cost is increased by orders of magnitude as shown in FIG. 9. Here it is assumed the pump pulse energy for a small signal amplification (˜10 dB) in PSA₁, PSA₂, . . . , PSA_{N} and PSA_{c} in the optical error correction circuit is 100 fJ/pulse, and that for a large signal amplification (˜50 dB) in PSA₀ is 1 pJ/pulse. These numbers correspond to the experimental values for thin film LiNO3 ridge waveguide DOPO at a pump wavelength of 780 nm and a pump pulse duration of 100 femtoseconds [15]. The pump energy consumed in the optical error correction circuit is estimated as E_{correction}=[(N+1)×10⁻¹³. The energy consumption in the pump pulse factory consists of three parts: those of a 100 GHz soliton frequency comb generator, EOM modulators and phase sensitive amplifiers (FIG. 6(b)). The 100 GHz soliton frequency comb generator requires an input power of ˜100 mW. [16] The 100 GHz EOM modulators require ˜400 mW electrical input power for each. [17] The energy cost per pulse for PSAₚ is ˜1 pJ, while those for N PSAs for storage ring cavities are ˜100 fJ. Note that NEOMₛ(EOM₁, EOM₂,:::EOM_{N}) need to be operated only for initial one round trip time, 10⁻¹¹ N (sec). The operational powers of active devices in 100 GHz CIM are summarized in FIG. 2A. The energy cost in the pump pulse factory is E_{factory}=[1.3×10⁻¹¹ N (MVM)+4×10⁻¹² N²+(10⁻¹²+10⁻¹³ N) (MVM)N](J). FIG. 2B summarizes the energy costs in the three parts of CIM. In FIG. 9, the energy-to-solution is shown if the CIM-CFC algorithm is implemented on GPU. The detailed description of this approach will be given below. Even though optical implementation of the error correction circuit and pump pulse factory as described in FIG. 6 is technologically challenging, the energy cost can be decreased by orders of magnitude compared to a modern GPU.

### CIM-Inspired Heuristic Algorithms-Scaling Performance of CIM-CAC, CIM-CFC and CIM-SFC

To test if the three classical nonlinear dynamics models, eqs. (1), (2), (3), (4), (5), (6), (7), and (8), are good Ising solvers, it is possible to numerically integrate them on a digital platform. Additionally, to ensure numerical stability, the range of some variables are constrained, the details of which can be seen in Appendix A. The relevant performance metric is the time to solution: TTS (the number of integration time steps to get 99% success rate). In particular, how the median TTS scales as a function of problem size for randomly generated Sherrington-Kirkpatrick (SK) spin glass instances (couplings are chosen randomly between +1 and −1) are compared. The median TTS is computed based on a set of 100 randomly generated instances per problem size, and 3200 trajectories are used per instance to evaluate the TTS.

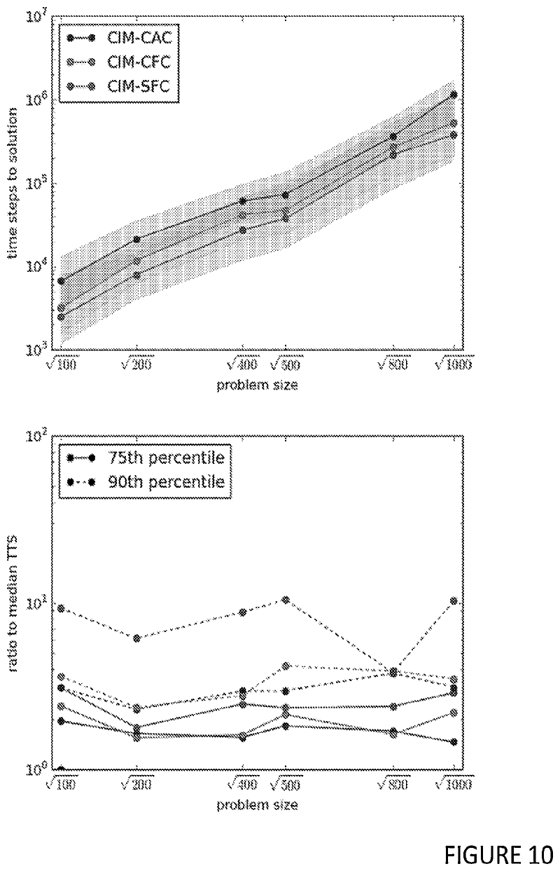

In FIG. 10, the median TTSs of the three CIM-inspired algorithms (CIM-CAC, CIM-CFC, CIM-SFC) are shown with respect to problem size. The shaded regions represent 25-75 percentile. The linear behavior of the TTS vs. \sqrt{N} indicates that those algorithms have the same root exponential scaling of TTS that is also observed in physical CIMs with quantum noise from external reservoirs. [8; 31] All three algorithms appear to have very similar scaling coefficients if the TTS is assumed to be of the form TTS≈A·^{B\sqrt{n}}. In addition to similar scaling, all three algorithms show a similar spread (25-75 percentile) in TTS as depicted by the shaded region above. Although CIM-SFC may have a slightly larger spread in all cases, the spread does not appear to increase for larger problem sizes.

### CIM-Inspired Heuristic Algorithms-Comparison to Noisy Mean Field Annealing (NMFA)

In order to show the importance of the auxiliary variable (error pulse) in CIM-SFC, its performance was compared to another CIM-inspired algorithm known as Noisy Mean Field

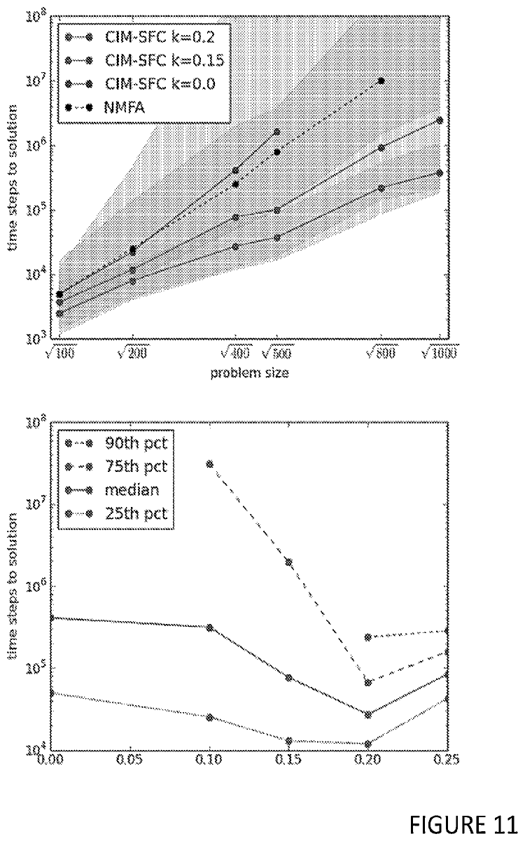

Annealing (NMFA). [26] NMFA also applies a hyperbolic tangent function to the mutual coupling term. However, NMFA does not have an auxiliary variable and relies on (artificial) quantum noise to escape from local minima. In FIG. 11, the scaling of NMFA to CIM-SFC is compared with different values of the feedback parameter k. Since the parameter k controls the strength of a destabilization force caused by the auxiliary variable, the importance of the term k (zᵢ-eᵢ) may be measured to the scaling behavior. In the case where k=0, CIM-SFC is almost identical to NMFA. The fact that CIM-SFC with k=0 has slightly worse performance indicates that the noise included in NMFA likely has a small effect and may help to destabilize local minima (which can also be observed in FIG. 7). The case k=0.15 is shown as an intermediate case, and k=0.2 is the (experimentally obtained) optimal value for k in CIM-SFC. The addition of the error correction feedback term k (zᵢ-eᵢ) in eqn. (7) is effective at improving both the scaling and spread of TTS on SK instances. This implies that the “correlated artificial noise” provided by the auxiliary variable is more effective at finding better solutions than “random quantum noise” from reservoirs.

CIM-Inspired Heuristic Algorithms-Comparison to Discrete Simulated Bifurcation Machine (dSBM)

The performance of the CIM-inspired algorithms may also be compared to another heuristic Ising solver known as the discrete simulated bifurcation machine (dSBM). [27; 29; 28] Similar to the CIM, dSBM also makes use of analog spins and continuous dynamics to solve combinatorial optimization problems. The authors of seem to claim that dSBM is algorithmically superior to CIM-CAC by comparing the required number of matrix-vector-multiplications (MVM) to solution. Although the authors of discussed the wall clock TTS of their implementations on many problem sets, when making the claim of algorithmic superiority they only used median TTS (in the units of MVM) on SK instances for two problem sizes.

To assess these methods, a more in-depth comparison of the three algorithms (CIM-CAC, CIM-CFC and CIM-SFC) to dSBM by using MVM to solution (or equivalently, integration time steps to solution) as the performance metric may be used. This is a good comparison because all of these algorithms will have the matrix-vector-multiplication as the computational bottleneck when implemented on a digital platform. As discussed above, the computation of the Ising energy can be left until the end of the trajectory in most cases, thus only the MVM involved in computation of the mutual coupling term is considered when calculating MVM to solution.

The problem instance sets used for the comparison may include: 1) A set of 100 randomly generated 800-spin SK instances. This instance set contains fully connected instances with +1, −1 weights; 2) The G-set instances which have been used as a benchmark for Max-Cut performance (available at https://web.stanford.edu/yyye/yyye/Gset/). For this comparison, 50 instances of problem size 800-2000 are used and these instances have varying edge density and either include +1, 0 weights or +1, 0, −1 weights; and 3) Another set of 1000 randomly generate 800-spin and 1200-spin SK instance used to evaluate worst-case performance.

In order to compare the performance on the 800-spin SK instances, the dSBM algorithm was also implemented on GPU. The parameters for dSBM were chosen based on the parameters in and can be found in Appendix D.

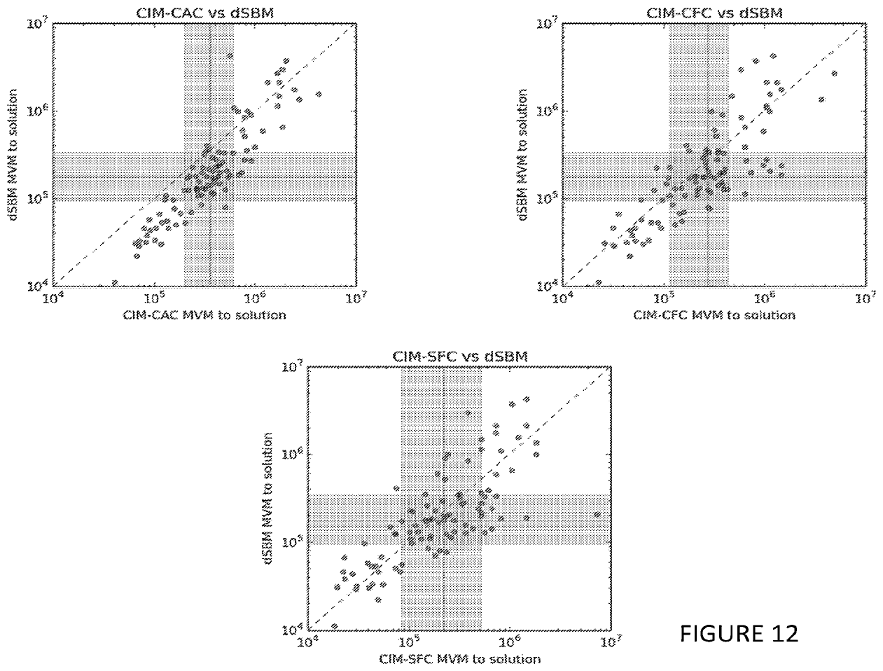

FIG. 12 shows the performance of three algorithms (CIM-CAC, CIM-CFC, and CIM-SFC) is compared instance by instance to dSBM on the 800-spin SK instances set. The ground state energies used to evaluate MVM to solution are the lowest energies found by four algorithms. Since all four algorithms found the same lowest energies, it is highly likely that these are true ground state energies. Parameters for all four systems can be found in the Appendix A. When comparing performance on the 800-spin instances in FIG. 12, all four systems show remarkably similar performance when parameters are optimized. It is important to note that with the parameters used in FIG. 12, CIM-SFC did not find the ground state in one instance. However, if different parameters are used, CIM-SFC will find the ground state for this particular instance as well. This means that although CIM-SFC can achieve high performance it is very sensitive to parameter selection.

The median TTS (in the units of MVM) of CIM-CFC, CIM-SFC and dSBM are nearly the same: around 2×10⁵. Furthermore, the spread in TTS of these three algorithms is pretty similar. Although CIM-CAC has slightly worse median TTS (less than a factor of 2 worse), it is worth noting that the instances in which CIM-CAC performs better than dSBM tend to be the harder instances. This may indicate that out of the four algorithms, CIM-CAC may have slightly better worst-case performance. This pattern can also be seen on the G-set.

Overall, all four algorithms show similar performance on the fully connected instances set and it is impossible to make a conclusion as to which particular algorithm is most effective for this problem type. In addition to similar median TTS and spread, there is a high level of correlation in TTS between all four systems. This can either indicate that instance difficulty is a universal property for all Ising heuristics or there is something fundamentally common about the four algorithms discussed. Appendix E contains a further discussion of the similarities and differences between these four systems.

Although CIM-SFC shows good performance on fully connected problem instances, it struggles on many G-set instances. Appendix D contains a partial reason for this failure but the full reason is not understood. For some results of CIM-SFC on the G-set see Appendix D.

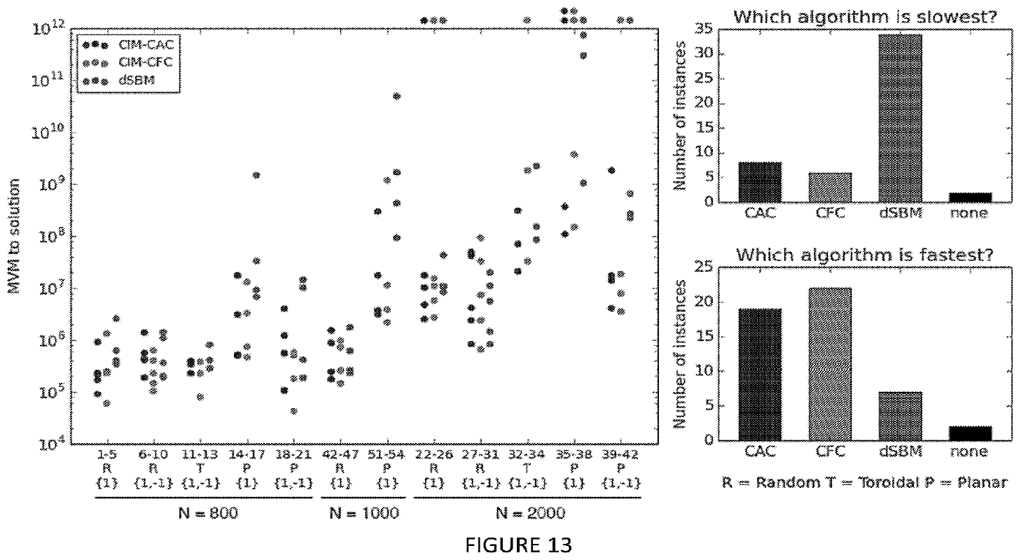

All three algorithms (CIM-CAC, CIM-CFC and dSBM) show fairly good performance on the G-set, however, CIM-CAC appears to be the more consistently effective algorithm out of the three. CIM-CAC and dSBM were able to find the best known cut values in 47/50 instances while CIM-CFC found the best known cut value in 45/50 instances. It is worth noting that the simulation time used to calculate the TTS for dSBM [29] was much longer than used in this comparison. Given the same simulation time, dSBM most likely would only have solved 45/50 instances. As demonstrated in FIG. 13, CIM-CAC and CIM-CFC are faster (in the units of MVM) than dSBM for most instances. More importantly, out of the instances in which dSBM is faster, there are no cases where dSBM is significantly faster than CIM-CAC, other than G37 in which CIM-CAC did not find the best known cut value. On the other hand, we counted 13/50 instances in which CIM-CAC was more than an order of magnitude faster than dSBM and CIM-CAC is a more reliable algorithm when considering many problem types.

The difference between CIM-CAC and CIM-CFC is subtle. This is to be expected as the dynamics of the two systems are very similar. Although the performance of the two algorithms for G-set is nearly identical in most cases, for some of the harder instances there are some cases where CIM-CFC cannot find the best known cut value or CIM-CFC has significantly longer TTS. This could indicate that CIM-CAC is fundamentally a more promising algorithm or that precise parameter selection for CIM-CFC is needed.

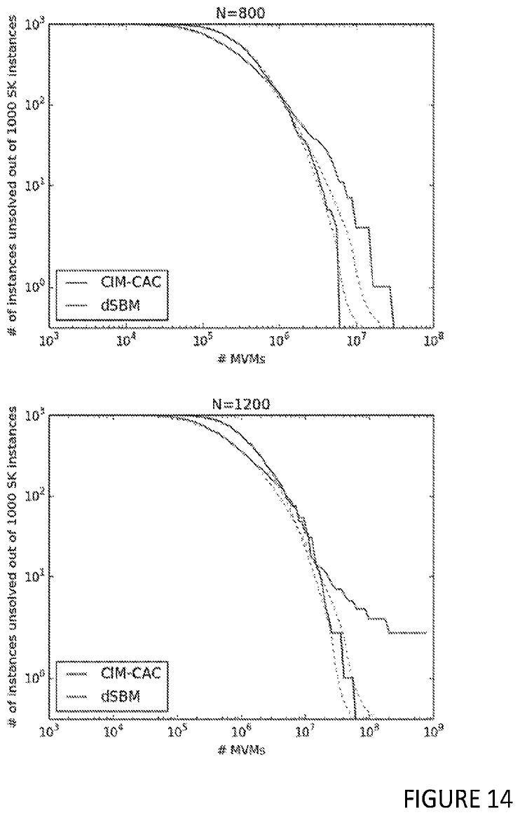

As noted in FIG. 12, the worst case performance of CIM-CAC may be slightly better than that of dSBM. To evaluate this further, new sets of 1000 800-spin and 1200-spin SK instances were created. In FIG. 14, the number of instances solved as a function of number of MVM required to achieve 99% success probability is plotted. In both cases, dSBM is able to solve the easier instances with a fewer number of MVM but for the hardest instances CIM-CAC is faster. This can be understood by observing the cross point of the two curves in FIG. 14.

In nearly all cases the best Ising energy found was the same for both solvers when a similar number of MVMs were used (see Appendix A for parameters). However for two instances in the N=1200 instances set the Ising energy found by CAC was not found by dSBM. This remained true even when 50,000 dSBM trajectories were used on these instances.

Based on our results it appears that dSBM may struggle greatly on some harder SK instances. However, it is possible that this could be a result of sub-optimal parameter selection for dSBM. The parameters used (see appendix A) were optimized by hand to have a good median TTS, however they may not be the best parameters if one wants to solve the hardest instances. For CIM-CAC however, the optimal parameters for the median TTS appear to also perform well on the hardest instances.

In order to be sure that an Ising solver has found the true ground state of a given problem, worst case performance is very important. For this purpose, CIM-CAC is likely the more fundamentally superior algorithm, at least in the case of randomly generated SK instances. For the other CIM modifications this is likely not true. In particular, for CIM-SFC the worst case performance is significantly worse than dSBM and CIM-CAC (as shown in FIG. 10).

The proposed CIM-inspired algorithms disclosed herein have proven to be fast and accurate Ising solvers even when implemented on a current digital platform. The performance is very similar to other existing analog-system-based algorithms such as dSBM. This again brings up the question raised in of whether the simulation of analog spins on a digital computer can outperform a purely discrete heuristic algorithm.

The foregoing description, for purpose of explanation, has been with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include and/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general-purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software, and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

### Appendix A: Optimization of Simulation Parameters

Here we summarize the simulation parameters used in our numerical experiments. The parameters are optimized empirically and thus do not necessarily reflect true optimum values.

### Parameters in FIG. 5

| | CIM-SFC (upper left panel) |
|---|---|
| N step | 500 |
| ΔT | 0.4 |
| p | −1.0 |
| c | 1.0 |
| β | 0.3 |
| k | 0.2 |
| | CIM-SFC (lower left panel) |
| N step | 500 |
| ΔT | 0.4 |
| p | −1.0 → 1.0 |
| c | 1.0 → 3.0 |
| β | 0.3 → 0.1 |
| k | 0.2 |
| | CIM-CFC (upper right panel) |
| N step | 1000 |
| ΔT | 0.4 |
| p | −1.0 |
| α | 1.0 |
| β | 0.2 |
| | CIM-CFC (lower right panel) |
| N step | 1000 |
| ΔT | 0.4 |
| Tᵣ | 900 |
| Tₚ | 100 |
| p | −1.0 → 1.0 |
| α | 1.0 |
| β | 0.2 |

### Parameters Used in FIGS. 10, 11, and 12

### CIM-CAC

In our simulation, xᵢ variables are restricted to the range [− 3/2\sqrt{α}, 3/2\sqrt{α}] at each time step. The parameters p and α are modulated linearly from their starting to ending values during the Tᵣ time steps and are kept at the final value for an additional Tₚ time steps. The initial value xᵢ is set to a random value chosen from a zero-mean Gaussian distribution with standard deviation of 10⁻⁴ and eᵢ =1. 3200 trajectories are computed per instance to evaluate TTS. Actual parameters used for simulation are listed below:

| N step | 3200 |
|---|---|
| ΔT | 0.125 |
| Tᵣ | 2880 |
| Tₚ | 320 |
| p | −1.0 → 1.0 |
| α | 1.0 → 2.5 |
| β | 0.8 |

### CIM-CFC

In our simulation x; variables are restricted to the range [−1.5, 1.5] and eᵢ is restricted to the range [0.01, ∞]. The parameter p is modulated linearly from its starting to ending values during the first Tᵣ time steps and kept at the final value for an additional Tₚ time steps. The initial value xᵢ is set to a random value chosen from a zero-mean Gaussian distribution with standard deviation of 0.1 and eᵢ =1. 3200 trajectories are computed per instance to evaluate TTS. Actual parameters used for simulation are listed below:

| N step | 1000 |
|---|---|
| ΔT | 0.4 |
| Tᵣ | 900 |
| Tₚ | 100 |
| p | −1.0 → 1.0 |
| α | 1.0 |
| β | 0.2 |

### CIM-SFC

Restriction of xᵢ and eᵢ variables is not needed as this system is more numerically stable. The parameters p, c and β are modulated linearly from their starting to ending values during simulation. The initial value xᵢ is set to a random value chosen from a zero-mean Gaussian distribution with standard deviation of 0.1 and eᵢ=0. 3200 trajectories are computed per instance to evaluate TTS. Actual parameters used for simulation are listed below:

| N step | 500 |
|---|---|
| ΔT | 0.4 |
| p | −1.0 → 1.0 |
| c | 1.0 → 3.0 |
| β | 0.3 → 0.1 |
| k | 0.2 |

In addition to the above parameters, it is important for the normalizing factor ξ for the mutual coupling term to be chosen as [31],

$$ξ = \sqrt{\frac{2 N}{Σ {J}_{ij}^{2}}} .$$

This choice is crucial for the successful performance in CIM-SFC but not in CIM-CAC and CIM-CFC. Additionally, it is important to note that we used the same number of time steps for all problem sizes in FIGS. 10 and 11. It is likely that the optimal number of time steps is smaller for smaller problem sizes, thus the scaling of TTS when the number of time steps is optimized separately for each problem size might be slightly worse than the reported scaling. However, we do not think this difference would be very significant. For the scaling of TTS for CIM-CAC when different parameters are chosen see Appendix C.

dSBM

For FIG. 12, dSBM is implemented as described in [29]. The parameters used are

| N step | 2000 |
|---|---|
| ΔT | 1.25 |
| c | 0.5 |

### Parameters Used in FIG. 14

Parameters for N=800 are the same as for FIG. 12. Parameters for N=1200 are shown below. The number of trajectories used for N=1200 was 3200 for most instances however to accurately evaluate the success probability 10000-50000 trajectories were computed for the 10 hardest instances for both algorithms. Also, due to the hardness in the case of N=1200 we are not very certain that the true ground state was found.

CIM-CAC

| N step | 8000 |
|---|---|
| ΔT | 0.125 |
| Tᵣ | 7200 |
| Tₚ | 800 |
| p | −1.0 → 1.0 |
| α | 1.0 → 2.5 |
| β | 0.8 |

dSBM

| N step | 4000 |
|---|---|
| ΔT | 1.25 |
| c | 0.5 |

### Numerical Integration

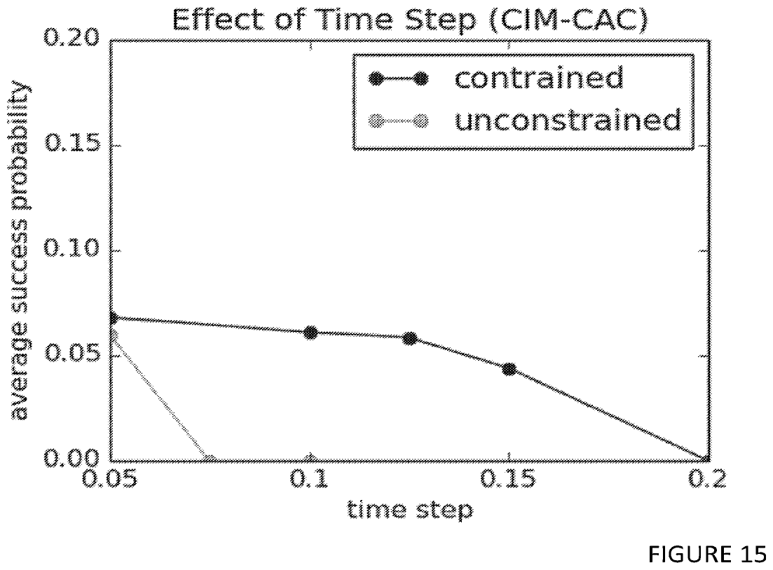

Euler step is used for integration in all cases (except for dSBM). As described above we constrain the range of x; variables in order to ensure numerical stability. This is not necessary for performance but allows us to increase the integration time step by a factor of 2 or 3 without loss of success probability. In FIG. 15 we show the success probability of CIM-CAC with respect to time step for both constrained and unconstrained systems.

The results in Section 5 for CIM-CFC do not use this numerical constraint the CIM in Section 5 is meant to be a physical machine and a time step of 0.2 is used.

### Appendix B: Simulation Results for G-Set

The results in FIG. 13 for dSBM are taken directly from the GPU implementation of dSBM in [29]. The unit for TTS in Table 3 is time steps to solution, or equivalently, MVM to solution. In our simulation, either 3200, 10000, or 32000 trajectories were generated to evaluate the TTS depending on the instance difficulty. The numbers in bold are the best TTS out of the three algorithms.

### CIM-CAC Parameters for G-Set

Variables are restricted as described in Appendix A, and the initial conditions are set in the same way. The following parameters are the same for all G-set instances.

| | |
|---|---|
| α | 1.0 → 3.0 |
| β | 0.3 |

While the parameters p, ΔT and the number of time steps used in each phase are chosen by instance type as follows:

| Graph Type | Edge Weight | N | Instance # | p | N step | ΔT | Tᵣ | Tₚ |
|---|---|---|---|---|---|---|---|---|
| Random | {+1} | 800 | 1-5 | −0.5 → 1.0 | 6666 | 0.075 | 6000 | 666 |
| Random | {+1, −1} | 800 | 6-10 | −0.5 → 1.0 | 6666 | 0.075 | 6000 | 666 |
| Toroidal | {+1, −1} | 800 | 11-13 | −4.0 | 5000 | 0.1 | 4500 | 500 |
| Planar | {+1} | 800 | 14-17 | −1.0 | 20000 | 0.05 | 18000 | 2000 |
| Planar | {+1, −1} | 800 | 18-21 | −1.0 | 20000 | 0.05 | 18000 | 2000 |
| Random | {+1} | 1000 | 43-46 | −0.5 → 1.0 | 10000 | 0.1 | 9000 | 1000 |
| Planar | {+1} | 1000 | 51-54 | −1.0 | 20000 | 0.05 | 18000 | 2000 |
| Random | {+1} | 2000 | 22-26 | −0.5 → 1.0 | 20000 | 0.1 | 19000 | 1000 |
| Random | {+1, −1} | 2000 | 27-31 | −0.5 → 1.0 | 20000 | 0.1 | 19000 | 1000 |
| Toroidal | {+1, −1} | 2000 | 32-34 | −4.0 → −3.0 | 20000 | 0.1 | 19000 | 1000 |
| Planar | {+1} | 2000 | 35-38 | −1.0 → −0.5 | 80000 | 0.05 | 78000 | 2000 |
| Planar | {+1} | 2000 | 39-42 | −1.0 → −0.5 | 80000 | 0.05 | 78000 | 2000 |

### CIM-CFC Parameters for G-Set

Variables are restricted as described in Appendix A, and the initial conditions are set in the same way. The following parameters are the same for all G-set instances.

| | |
|---|---|
| α | 1.0 |
| β | 0.15 |

While the parameters p, ΔT and the number of time steps used in each phase are chosen by instance type as follows:

| Graph Type | Edge Weight | N | Instance # | p | N step | ΔT | Tᵣ | Tₚ |
|---|---|---|---|---|---|---|---|---|
| Random | {+1} | 800 | 1-5 | −1.0 → 1.0 | 4000 | 0.125 | 3600 | 400 |
| Random | {+1, −1} | 800 | 6-10 | −1.0 → 1.0 | 2000 | 0.25 | 1800 | 200 |
| Toroidal | {+1, −1} | 800 | 11-13 | −3.0 → −1.0 | 2000 | 0.25 | 1800 | 200 |
| Planar | {+1} | 800 | 14-17 | −2.0 → 0.0 | 8000 | 0.125 | 7200 | 800 |
| Planar | {+1, −1} | 800 | 18-21 | −2.0 → 0.0 | 4000 | 0.25 | 3600 | 400 |
| Random | {+1} | 1000 | 43-46 | −1.0 → 1.0 | 5000 | 0.2 | 4500 | 500 |
| Planar | {+1} | 1000 | 51-54 | −2.0 → 0.0 | 16000 | 0.125 | 15200 | 800 |
| Random | {+1} | 2000 | 22-26 | −1.0 → 1.0 | 10000 | 0.2 | 9500 | 500 |
| Random | {+1, −1} | 2000 | 27-31 | −1.0 → 1.0 | 10000 | 0.2 | 9500 | 500 |
| Toroidal | {+1, −1} | 2000 | 32-34 | −3.0 → −1.0 | 40000 | 0.1 | 39000 | 1000 |
| Planar | {+1} | 2000 | 35-38 | −2.0 → 0.0 | 80000 | 0.05 | 78000 | 2000 |
| Planar | {+1} | 2000 | 39-42 | −2.0 → 0.0 | 40000 | 0.1 | 39000 | 1000 |

### Appendix C: Reasoning for Parameter Selection

Parameters are selected numerically for the most part, however, the choice of p, α and β can be understood in the following way. It is observed that the average residual energy visited by CIM-CAC during the search process can be roughly estimated by the formula. (11)

$$Δ {E}_{avg} \approx K \frac{1 - p}{αβ}$$

Where K is a constant only depending on problem type and size. This formula essentially predicts the effective sampling temperature of the system (although the distribution may not be an exact Boltzmann distribution). Based on this philosophy we gradually reduce the “system temperature” to produce an annealing effect. This is the motivation behind increasing p and α. The different choice for the range of p on different G-set instances reflects the vastly different values for the constant K depending on the structure of the max-cut problem. In a more general setting the value of K can be predicted based on the problem type and thus the range for p and a can be chosen accordingly. Although it has not been verified, a similar formula most likely hold for CIM-CFC and thus the parameters for CIM-CFC are chosen in the same way.

Optimal Parameters with Respect to Problem Size (CIM-CAC)

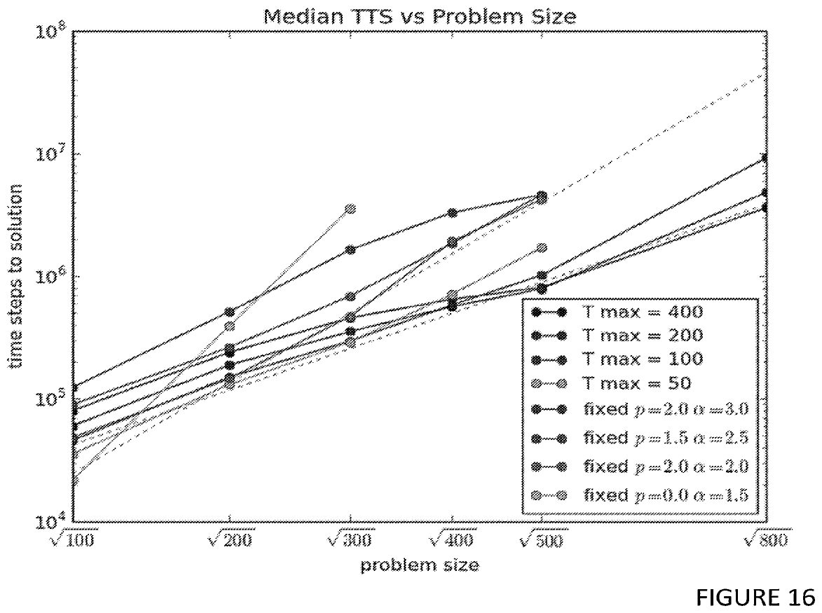

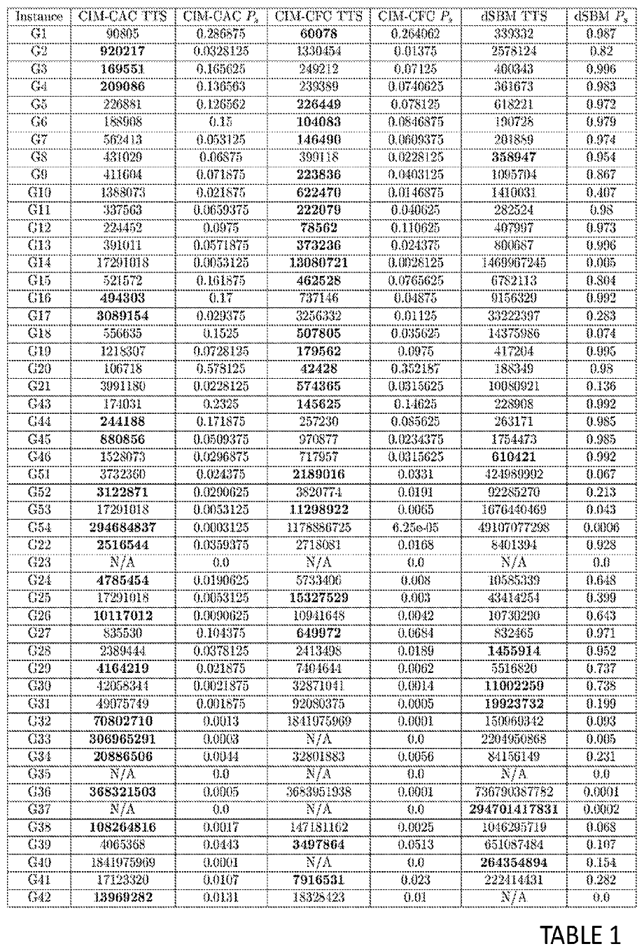

In FIG. 16 we can see the difference in scaling when parameters are fixed (red shades) compared to when paramaters are modulated linearly (blue shades). Additionally, the optimal anneal time (in other words the optimal speed of modulation) will change with respect to problem size since for large problem sizes we need long anneal times to get good results. This pattern was also used when choosing parameters on the G-set.

Although FIG. 16 was created using the gaussian quantum model for CIM-CAC in an MFB-CIM (see [31]) the difference in performance between this model and the noiseless model discussed in this paper is insignificant since g²=10⁻⁴ was used. It should also be noted that a time step of 0.01 was used in FIG. 16. This is why the TTS in FIG. 16 is an order of magnitude longer than the results discussed in this paper in which a time step of 0.125 was used.

### Appendix D: Results and Discussion for CIM-SFC on G-Set

Based on our current understanding of CIM-SFC, it is very important that the term tanh (czᵢ) transi-tions from “soft spin” mode when czᵢ≈0 and tanh (czᵢ)≈czᵢ to “discrete spin” mode where |czᵢ|>>0 and tanh (ca)≈sign (czᵢ). This is why we use the normalizing factor ξ (as defined above) as this en-sures zᵢ will on average be around \sqrt{2} for a randomly chosen spin configuration, thus we can use the same value for c in all cases and get similar results. However, this only works for instances such as SK instances where each node has equal connectivity and thus we can expect zᵢ to have roughly the same range of values for all i.

On some G-set instances, in particular the planar graph instances, some nodes have a much larger de-gree, thus cz; will be too large in some cases and too small in others no matter what normalizing factor ξ we use. This may be one of the reasons why CIM-SFC struggles on many G-set instances and especially the planar graphs. This also could be the reason that dSBM struggles on planar graphs since dSBM relies on the same normalizing factor to get good results. CIM-CAC and CIM-CFC do not need this normalizing factor since they automatically compensate for different values of ΣⱼJᵢⱼσⱼ, and this might be the reason they perform well on planar graphs.

For toroidal graphs on the other hand, the opposite is true, since ΣⱼJᵢⱼσⱼ can only take on 5 different values for these graphs. This could mean that the transition from “soft spin” to “discrete spin” is very quick in the case of CIM-SFC thus we need to carefully tune the parameters to get good results on these graphs.

Although this observation regarding the analog/discrete transition may partially explain the poor results on the G-set, this is not a complete explanation. For example, CIM-SFC struggles on some random graphs (such as G9) which do not have the above property since each node has similar connectivity. Below are the results for CIM-SFC on the G-set as well as parameters used (not all instances were tested).

### Results for CIM-SFC on the G-Set

| Instance | TTS | Pₛ |
|---|---|---|
| G1 | 28470 | 0.194 |
| G2 | 1531984 | 0.004 |
| G3 | 130388 | 0.046 |
| G4 | 435510 | 0.014 |
| G5 | 380685 | 0.016 |
| G6 | 112834 | 0.0202 |
| G7 | 163316 | 0.014 |
| G8 | 125360 | 0.0182 |
| G9 | 4604018 | 0.0005 |
| G10 | 395845 | 0.0058 |
| G11 | 195461 | 0.0572 |
| G12 | 128184 | 0.0859 |
| G13 | 311368 | 0.0363 |
| G43 | 1702012 | 0.0134375 |
| G44 | 1742812 | 0.013125 |
| G45 | 73671209 | 0.0003125 |
| G46 | 1927483 | 0.011875 |

For instances G14-G21 (800 node planar graphs) and G51-G54 (1000 node planar graphs) CIM-SFC shows either zero or a very small nonzero success probability. 2000 node instances have not been tested yet.

### Parameters for CIM-SFC on G-Set

### Common Parameters

$$p \vert - 1. \to 1.$$

### Parameters Selected by Problem Type

| Graph Type | Edge Weight | N | Instance # | c | β | k | N step | ΔT |
|---|---|---|---|---|---|---|---|---|
| Random | {+1} | 800 | 1-5 | 1.0 → 3.0 | 0.3 → 0.0 | 0.2 | 2666 | 0.15 |
| Random | {+1, −1} | 800 | 6-10 | 1.0 → 3.0 | 0.3 → 0.0 | 0.2 | 500 | 0.4 |
| Toroidal | {+1, −1} | 800 | 11-13 | 1.4 | 0.05 → 0.0 | 0.32 | 2500 | 0.4 |
| Random | {+1} | 1000 | 43-46 | 1.4 → 4.2 | 0.2 → 0.0 | 0.2 | 5000 | 0.2 |

The parameters for CIM-SFC are chosen experimentally and the understanding of how the parameters effect performance and dynamics is limited. We hope that once this system is studied more thoroughly we will come up with a more systematic method of choosing parameters so good performance can be as-sured on many different problem types.

### Appendix E: Similarities and Differences Between CIM and SBM Algorithms

Using continuous analog dynamics to solve discrete optimization problems is a somewhat new concept and it is interesting to compare these different approaches. (13, 11, 29) In this appendix we will briefly dis-cuss some similarities and differences between the three CIM-inspired algorithms and the SBM algorithms.

All four systems discussed in Section 6, CIM-CAC, CIM-CAC, CIM-SFC and dSBM were originally inspired by the same fundamental principle [10, 27]:

The function

$$H ( x ) = {\sum }_{i} ( \frac{{x}_{i}^{2}}{4} - \frac{1 - p}{2} ) {x}_{i}^{2} + c {\sum }_{i} {\sum }_{j} {J}_{ij} {x}_{i} {x}_{j} \qquad ( D1 )$$

can be used as a continuous approximation of the Ising cost function.

In the original CIM algorithm, gradient descent is used to find local minima of H while H is deformed by increasing p. This system has two major drawbacks [10]:
1. Local minima are stable
2. Incorrect mapping of Ising problem to cost function due to amplitude heterogeneity.

All four algorithms discussed in Section 6 can be thought of as modifications of the original CIM algorithm that aim to overcome these two flaws.^{[11. 27. 28. 29]} In all of thee algorithms the first flaw is fixed by adding new degrees of freedom to the system so there are now 2N analog variables for N spins instead of only N. In SBM, this is done by including both a position vector, xᵢ, and a velocity/momentum vector, yᵢ, while in the modified CIM algorithms we add the auxiliary variable eᵢ.

To fix the second flaw, the creators of dSBM added discretization and “inelastic walls”, whereas in CIM-CFC and CIM-SFC, this discretization is not necessary. All three algorithms ensure, using different mech-anisms, that the systme only has fixed points at local minima of the Ising Hamiltonian (during the end of the trajectory), something which is not true for the original CIM algorithm. Because these systems are fundamentally very similar, it should not be too surprising that the systems can achieve similar performance as digital algorithms.

We would also like to note that in order for dSBM to achieve good performance, it is necessary to use discretization and inelastic walls which make the system discontinuous. This is very nice when implementing on a digital platform which prefers discrete processes, but when implementing these algorithms on an analog physical platform this is not preferred. In CIM-CAC, CIM-CFC and CIM-SFC, on the other hand, the system evolves continuously and thus they are much more suitable for analog implementation such as the optical CIM architecture proposed in this paper.

One interesting difference between the CIM and the original bifurcation machine in [27], which was named aSBM in [29], is that aSBM is a completely unitary dissipation-less system. Because of this, aSBM relies on adiabatic evolution for computation (similar to quantum annealing), unlike the dissipative CIM and other Ising heuristics (such as simulated annealing or breakout local search^{[14]}) which rely on some sort of dissipative relaxation. However, in the new SBM algorithms deviate from this concept of adiabatic evolution by adding inelastic walls, thus making the new bifurcation machine a dissipative system in which information is lost over time. It would be intersting to try to understand whether or not dissipation is in fact necessary for a system to achieve the high performance of the algorithms discussed in this paper. For example, one could modify aSBM in a different way which fixes the problem of amplitude heterogeneity but keeps the adiabatic nature. Whether or not this is possible is beyond the scope of this paper.

### Appendix F: Optical Implementation of CIM-SFC

FIG. 17 shows an optical implementation of CIM-SFC which is similar to that of CIM-CAC and CIM-CFC shown in FIG. 6. The feedback signal \tilde{z}ᵢ=ΣⱼJᵢⱼ\tilde{x}ⱼ is deamplified (rather than amplified) by PSA, with attenuation coefficient

$$\frac{tanh ( {\tilde{z}}_{i}^{( m )} )}{{\tilde{z}}_{i}^{( m )}} ,$$

where \tilde{z}ᵢ^{(m)} is an optical homodyne measurement result of \tilde{z}ᵢ. This feedback signal is then injected back into signal pulse xᵢ in the main cavity through BSᵢ. Part of the fan-in circuit output \tilde{z}ᵢ is delayed by a delay line DLₑ with delay time NT and combined with the error pulse eᵢ (inside the main cavity). This implements the term eᵢ-\tilde{z}ᵢ in equation (8). The term −β(eᵢ−\tilde{z}ᵢ) on the R.H.S. of equation (8) is implemented by a phase sensitive amplifier PSAₑ of the main cavity. This is also a deamplification process. Finally the error correction signal amplitude \tilde{e}ᵢ−\tilde{z}ᵢ, is coupled to the signal pulse xᵢ, inside the main cavity with a standard optical delay line.

What is claimed is:

1. A coherent Ising machine comprising:
a pump pulse generator configured to generate optical signal pulses;
an optical error correction circuit configured to generate optical error pulses; and
a main ring cavity configured to store the optical signal pulses and the optical error pulses, wherein the optical error pulses cause the coherent Ising machine not to converge on a local minima of Ising solution and continue to explore nearby states.

2. The coherent Ising machine of claim 1, further comprising:
a phase sensitive amplifier configured to squeeze the optical signal pulses such that the main ring cavity stores the optical signal pulses as squeezed optical signal pulses.

3. The coherent Ising machine of claim 1, further comprising:
a phase sensitive amplified configured to squeeze the optical error pulses such that the main ring cavity stores the optical error pulses as squeezed optical error pulses.

4. The coherent Ising machine of claim 1, wherein squared amplitude of the optical error pulses is smaller compared to a saturation level of an optical parametric oscillator of the main ring cavity.

5. The coherent Ising machine of claim 4, wherein the optical signal pulses are configured to be manipulated in both a linear amplifier/deamplifier regime and a non-linear oscillator regime.

6. The coherent Ising machine of claim 4, wherein the optical error pulses are configured to be manipulated in a linear amplifier/deamplifier regime.

7. The coherent Ising machine of claim 1, wherein the pump pulse generator, the main ring cavity, and the optical error correction circuit are integrated monolithically into a single chip.

8. The coherent Ising machine of claim 1, wherein the pump pulse generator is configured to generate the optical signal pulses as second harmonic generation pulses.

9. The coherent Ising machine of claim 1, wherein the optical error correction circuit comprises an optical homodyne detector configured measure amplitudes of the optical signal pulses and the optical error pulses.

10. The coherent Ising machine of claim 1, wherein the optical error correction circuit comprises a fan-out and a fan-in circuit configured to generate the optical error pulses with a predetermined amplitude.

11. A method of solving an Ising problem, the method comprising:
generating, by a pump pulse generator of a coherent Ising machine, optical signal pulses;
generating, by an optical error correction circuit of the coherent Ising machine, optical error pulses; and
storing, by a main ring cavity of the coherent Ising machine, the optical signal pulses and the optical error pulses, wherein the optical error pulses cause the coherent Ising machine not to converge on a local minima of Ising solution and continue to explore nearby states.

12. The method of claim 11, further comprising:
squeezing, by a phase sensitive amplifier of the coherent Ising machine, the optical signal pulses such that the main ring cavity stores the optical signal pulses as squeezed optical signal pulses.

13. The method of claim 11, further comprising:
squeezing, by a phase sensitive amplified of the coherent Ising machine, the optical error pulses such that the main ring cavity stores the optical error pulses as squeezed optical error pulses.

14. The method of claim 11, wherein squared amplitude of the optical error pulses is smaller compared to a saturation level of an optical parametric oscillator of the main ring cavity.

15. The method of claim 14, wherein the optical signal pulses are manipulated in both a linear amplifier/deamplifier regime and a non-linear oscillator regime.

16. The method of claim 14, wherein the optical error pulses are manipulated in a linear amplifier/deamplifier regime.

17. The method of claim 11, wherein the pump pulse generator, the main ring cavity, and the optical error correction circuit are integrated monolithically into a single chip.

18. The method of claim 11, further comprising:
generating, by the pump pulse generator of the coherent Ising machine, the optical signal pulses as second harmonic generation pulses.

19. The method of claim 11, further comprising:
measuring, by an optical homodyne detector of the optical error correction circuit, amplitudes of the optical signal pulses and the optical error pulses.

20. The method of claim 11, further comprising:
generating, comprises a fan-out and a fan-in circuit of the optical error correction circuit, the optical error pulses with a predetermined amplitude.
